(19) United States
(12) Patent Application Publication
(10) Pub. No.: US 2025/0004179 A1
(43) Pub. Date: Jan. 2, 2025

(54) HARDENED OPTICAL WINDOWS WITH ANTI-REFLECTIVE FILMS HAVING LOW REFLECTANCE AND HIGH TRANSMISSION IN MULTIPLE SPECTRAL RANGES

(71) Applicant: CORNING INCORPORATED, CORNING, NY (US)

(72) Inventors: Shandon Dee Hart, Elmira, NY (US); Karl William Koch, III, Elmira, NY (US); Carlo Anthony Kosik Williams, Painted Post, NY (US); Lin Lin, Painted Post, NY (US); Rui Luo, Fremont, CA (US); James Joseph Price, Corning, NY (US); Nicholas Michael Walker, Painted Post, NY (US)

(21) Appl. No.: 18/709,681

(22) PCT Filed: Nov. 3, 2022
(86) PCT No.: PCT/US2022/048800

§ 371 Date: May 13, 2024

Related U.S. Application Data
(60) Provisional application No. 63/289,828, filed on Dec. 15, 2021.
(60) Provisional application No. 63/280,869, filed on Nov. 18, 2021.

(51) Int. Cl. G02B 1/14; G01S 7/481; G02B 1/115; G02B 1/18; G02B 5/28

(52) U.S. Cl. CPC G02B 1/14; G01S 7/4813; G02B 1/115; G02B 1/18; G02B 5/281

(57) ABSTRACT

A window for a sensing system includes a first layered film and a second layered film. The first and second layered film each include alternating layers of lower and higher refractive index materials. The first layered film includes a scratch resistant layer such that the window exhibits a maximum nanoindentation hardness of greater than or equal to 10 GPa when indented on the first layered film. The materials and thicknesses of the layers of the first and second layered films are selected such that the window exhibits relatively high transmittance and low reflectance in two distinct wavelength ranges of interest.

### PRIORITY

This application claims the benefit of U.S. Application Nos. 63/280,869 filed Nov. 18, 2021 and 63/289828 filed Dec. 15, 2021, each of which is incorporated by reference herein in its entirety.

### FIELD OF INVENTION

The present application pertains to windows for sensing systems including one or more layered films for providing low reflectance and high transmission in multiple spectral ranges.

### BACKGROUND

Light detection and ranging (“LIDAR”) systems include a laser and a sensor. The laser emits a laser beam, which may reflect off an object, and the sensor detects the reflected laser beam. The laser beams are pulsed or otherwise distributed across a radial range to detect objects across a field of view. Information about the object can be deciphered from the properties of the detected reflected laser beam. Distance of the object from the laser beam can be determined from the time of flight from emission of the laser beam to detection of the reflected laser beam. If the object is moving, path and velocity of the object can be determined from shifts in radial position of the emitted laser beam being reflected and detected as a function of time, as well as from Doppler frequency measurements.

LIDAR systems in automobiles, and other infrared sensing systems in exposed environments, such as aerospace or home security applications, need to be protected from the environment and various sources of damage, for example, with a covering lens or cover glass window. Vehicles are another potential application for LIDAR systems, with the LIDAR systems providing spatial mapping capability to enable assisted, semi-autonomous, or fully autonomous driving. In such applications, the laser emitter and sensor are mounted in an interior of a vehicle, on the roof of the vehicle or on a low forward portion of the vehicle. Lasers emitting electromagnetic radiation having a wavelength outside the range of visible light, such as within a wavelength range between 1400 nm and 1600 nm, may be considered for vehicle LIDAR applications. To protect the laser and sensor from impact from rocks and other objects, a window is placed between the laser and sensor, and the external environment in the line of sight of the laser and sensor. A window is similarly placed between the laser/sensor and the external environment for other applications of the LIDAR system, such as aerospace and home security applications. However, there is a problem in that rocks and other objects impacting the window scratch and cause other types of damage to the window, which cause the window to scatter the emitted and reflected laser beams, thus impairing the effectiveness of the LIDAR system.

Moreover, it may be desirable to employ additional sensors within a LIDAR system (e.g., sensors providing feedback by means other than a laser associated with the LIDAR system). Providing high fidelity data from such additional sensors may impose additional optical performance requires on the window used to protect the LIDAR system components. For example, such additional sensors may operate in a wavelength range that differs from an emission wavelength of the laser associated with the LIDAR system. Accordingly, it may be desirable to provide a window for a LIDAR system capable of providing relatively high transmission and low reflection in multiple distinct wavelength ranges of interest, while still providing scratch and damage resistance from external impacts.

### SUMMARY

The present disclosure solves that problem with a window that includes first and second layered films. The first layered film may face away from a laser/sensor of a LIDAR system and include a scratch resistant layer embedded therein to provide damage resistance to the window. Thus, rocks and other objects impacting the window are less likely to cause defects to the window that scatter the emitted and reflected electromagnetic radiation from the LIDAR sensor, resulting in improved performance. In addition, the first and second layered films further include alternating layers of materials having different indices of refraction (including the material providing the hardness and scratch resistance), such that the number of alternating layers and their thicknesses can be configured so that the window has high transmissivity and low reflection over a primary wavelength range of interest, centered at a desired emission wavelength of a laser of the LIDAR system (e.g., a desired wavelength between 1400 nm and 1600 nm). The alternating layers of material may be further selected such that the window provides high transmissivity and low reflection over a secondary wavelength range of interest, the secondary wavelength range of interest comprising an upper wavelength that differs from the desired emission wavelength by at least 400 nm (e.g., at least 450 nm, at least 500 nm, at least 550 nm, at least 600 nm, at least 700 nm). Such relatively high transmission over the distinct wavelength ranges of interest may facilitate the optical window having a clear, neutral appearance when viewed from the first layered film (e.g., from outside of the LIDAR system). Moreover, multiple sensors, each operating in one of the primary and secondary wavelength ranges of interest, may be incorporated into the LIDAR system. The windows described herein may facilitate incorporating multiple sensors into a single enclosure to facilitate compact sensor assemblies provided multiple types of feedback for incorporation into various types of systems in automobiles or other applications.

According to an embodiment of the present disclosure, a window for a sensing system includes a substrate comprising a first surface and a second surface, the first surface and the second surface being primary surfaces of the substrate; a first layered film disposed on the first surface of the substrate, the first layered film comprising alternating layers of one or more higher refractive index materials and one or more lower refractive index materials, wherein refractive indices of the one or more higher refractive index materials of the first lavered film are higher than refractive indices of the one or more lower refractive index materials of the first layered film; a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film; and a maximum hardness, measured at the first layered film and by the Berkovich Indenter Hardness Test, of at least 10 GPa. The quantity, the thicknesses, and materials of the alternating layers of the first and second layered films are configured so that the window has; an average percentage transmittance, calculated over a 50 nm wavelength range of interest surrounding a central wavelength between 1400 nm and 1600 nm, of greater than 90% for light incident on the first surface and the second surface at angles of incidence of less than or equal to 15°; an average reflectance, calculated over the 50 nm wavelength range of interest, of less than 0.5% for light incident on the first surface and the second surface at angles of less than or equal to 15°; and an average percentage transmission, calculated from 400 nm to 700 nm, of greater than 80% for light incident on the first surface and the second surface at angles of incidence of less than or equal to 15°.

According to another embodiment of the present disclosure, a window for a sensing system includes a substrate comprising a first surface and a second surface, the first surface and the second surface being primary surfaces of the substrate; a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film; a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film; and a maximum hardness, measured at the first layered film and by the Berkovich Indenter Hardness Test, of at least 10 GPa. The quantity, the thicknesses, and materials of the alternating layers of the first and second layered films are configured so that the window has: an average reflectance, calculated over a 50 nm wavelength range of interest surrounding a central wavelength between 1400 nm and 1600 nm, of less than 0.5% for light incident on the first surface and the second surface at angles of less than or equal to 15°; CIELAB a* and b* values of greater than or equal to −6.0 and less than or equal to 6.0 when viewed from a side of the first layered film; and an average percentage transmission, calculated from 400 nm to 700 nm, of greater than 70% for light incident on the first surface and the second surface at angles of incidence of less than or equal to 15°.

According to another embodiment of the present disclosure, a window for a sensing system includes a substrate comprising a first surface and a second surface, the first surface and the second surface being primary surfaces of the substrate; a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film; a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film; and a maximum hardness, measured at the first layered film and by the Berkovich Indenter Hardness Test, of at least 10 GPa, The quantity, the thicknesses, and materials of the alternating layers of the first and second layered films are configured so that the window has: an average reflectance, calculated over a 50 nm wavelength range of interest between 1400 nm and 1600 nm, of less than 0.5% for light incident on the first surface and the second surface at angles of less than or equal to 15°; an average percentage transmission, calculated from 400 nm to 700 nm, of greater than 70% for light incident on the first surface and the second surface at angles of incidence of less than or equal to 15°; and an average reflectance, calculated from 400 nm to 700 nm, for light normally incident on the first layered film, of less than or equal to 30%.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a side view of a vehicle in an external environment, illustrating a LIDAR system on a roof of the vehicle and another LIDAR system on a forward portion of the vehicle, according to one or more embodiments of the present disclosure;

FIG. 2 is a schematic view of one of the LIDAR systems of FIG. 1, illustrating an electromagnetic radiation emitter and sensor in an enclosure, and the electromagnetic radiation emitter and sensor emitting electromagnetic radiation that exits the enclosure through a window and returns as reflected radiation through the window, and a secondary sensor receiving additional radiation through the window, according to one or more embodiments of the present disclosure;

FIG. 3 is a cross-sectional view of the window of FIG. 2 taken at area III of FIG. 2, illustrating the window including a substrate with a first layered film over a first surface of the substrate, and a second layered film over a second surface of the substrate, according to one or more embodiments of the present disclosure;

FIG. 4 is a cross-sectional view of the window of FIG. 3 taken at area IV of FIG. 3, illustrating the first layered film including alternating layers of one or more higher refractive index materials and one or more lower refractive index materials with a layer of the one or more lower refractive index materials providing a terminal surface closest to the external environment, according to one or more embodiments of the present disclosure;

FIG. 5 is a cross-sectional view of the window of FIG. 3 taken at area V of FIG. 3, illustrating the second layered film including alternating layers of one or more higher refractive index materials and one or more lower refractive index materials with a layer of the one or more lower refractive index materials providing a terminal surface closest to the electromagnetic radiation emitter and sensor, according to one or more embodiments of the present disclosure;

FIG. 6 is a graph of a modeled two-surface transmittance for light in an infrared wavelength range of interest from 1500 nm to 1600 nm that is normally incident on the first layered film of the example window, according to one or more embodiments of the present disclosure;

FIG. 7 is a graph of a modeled two-surface transmittance for s and p polarized light in an infrared wavelength range of interest from 1500 nm to 1600 nm that is incident on the first layered film of the first example window at a 60 degree angle of incidence, according to one or more embodiments of the present disclosure;

FIG. 8 is a graph of a modelled two-surface reflectance for light in an infrared wavelength range of interest from 1500 nm to 1600 nm that is normally incident on the first and second layered films of the first example window, according to one or more embodiments of the present disclosure;

FIG. 9 is a graph of modelled two-surface transmittance, for light in the visible spectrum, and incident on the first layered film of the first example window at angles of incidence of 0° (i.e., normally incident), 45°, and 60°, according to one or more embodiments of the present disclosure;

FIG. 10 is a graph of CIELAB color space values a* and b* for light incident on the first and second layered films of the first example window at a plurality of angles of incidence, according to one or more embodiments of the present disclosure;

FIG. 11A is a graph of a modeled two-surface transmittance for light in an infrared wavelength range of interest from 1500 nm to 1600 nm that is normally incident on a first layered film of a second example window, according to one or more embodiments of the present disclosure;

FIG. 11B is a graph of a modelled two-surface reflectance for light in an infrared wavelength range of interest from 1500 nm to 1600 nm that is normally incident on the second example window, according to one or more embodiments of the present disclosure;

FIG. 11C is a graph of a modeled two-surface transmittance for s and p polarized light in an infrared wavelength range of interest from 1500 nm to 1600 nm that is incident on the first layered film of the second example window at a 60 degree angle of incidence, according to one or more embodiments of the present disclosure;

FIG. 12 is a graph of modelled two-surface transmittance, for light in the visible spectrum, and incident on the first layered film of the second example window at angles of incidence of 0° (i.e., normally incident), 45°, and 60°, according to one or more embodiments of the present disclosure;

FIG. 13A is a graph of CIELAB color space values a* and b* for light incident on the first layered film of the second example window at a plurality of angles of incidence, according to one or more embodiments of the present disclosure; and

FIG. 13B is a graph of CIELAB L* values for light incident on the first layered film of the second example window at a plurality of angles of incidence, according to one or more embodiments of the present disclosure.

### DETAILED DESCRIPTION

Reference will now be made in detail to embodiments of windows for use in LIDAR sensors and/or mobile electronic devices. Whenever possible, the same reference numerals will be used throughout the drawings to refer to the same or like parts. The windows may include first and second layered films that are constructed of alternating layers of high and low refractive index materials and configured to provide relatively high transmittance and low reflectance in an infrared wavelength range of interest centered about a central wavelength that is between 1400 nm and 1600 nm. When the window is used in a LIDAR system, the first layered film may face away from the sensor/laser and be exposed to the environment, while the second layered film may face the sensor/laser. That is, when the LIDAR system is viewed from the outside, an observer may view the first layered film. Light emitted by a laser of the LIDAR system may be initially incident on the second layered film prior to propagating through the substrate. In accordance with the present disclosure, the fist layered films of the windows described herein may include scratch resistant layers that are relatively thick (e.g., greater than or equal to 500 nm) of a high refractive index material. The scratch resistant layer may be embedded within the first layered film such that the window comprises a maximum nanoindentation hardness of greater than or equal to 10 GPa (e.g., greater than or equal to 12 GPa) when measured at the first layered film by the Berkovich Indenter Hardness Test. Such nanoindentation hardness beneficially provides scratch resistance and improves performance of the LIDAR system.

In aspects, the alternating layers of the first and second layered films of the windows described herein are also constructed to provide optical performance attributes that are desirable for operation of the LIDAR system in the infrared spectrum. In embodiments, the quantity, the thicknesses, and materials of the alternating layers of the first and second layered films are configured so that the window has an average percentage transmittance, calculated over a 50 nm wavelength range of interest centered about a central wavelength that is greater than or equal to 1400 nm and less than or equal to 1600 nm, that is greater than 90% for light incident on the first surface and the second surface at angles within 15° of normal to the first surface and the second surface. The quantity, the thicknesses, and materials of the alternating layers of the first and second layered films may be configured so that the window also comprises an average percentage transmittance, calculated over the 50 nm wavelength range of interest from 1400 nm to 1600 nm, of greater than 85% for light incident on the first surface and the second surface at an angle of incidence of 60 degrees, irrespective of the polarization of the light (e.g., whether s-polarized or p-polarized). The quantity, the thicknesses, and materials of the alternating layers of the first and second layered films are configured so that the window has an average reflectance, calculated over the 50 nm wavelength range of interest, of less than 0.5% for light incident on the first layered film at angles of incidence of 15° or less.

In further aspects, the first and second layered films of the windows described herein may also be structured to provide relatively high transmittance and low reflectance over a secondary wavelength range of interest that is separate from the above-described 50 nm wavelength range of interest. In embodiments, the secondary wavelength range of interest comprises an upper wavelength that is separated from a lower wavelength of the 50 nm wavelength range of interest by at least 400 nm (e.g., at least 450 nm, at least 500 nm, at least 550 nm, at least 600 nm, at least 650 nm, at least 700 nm). For example, in embodiments, the quantity, the thicknesses, and materials of the alternating layers of the first and second layered films are configured so that the window has an average percentage transmission, calculated from 400 nm to 700 nm, of greater than 80% for light incident on the window at angles of incidence of less than or equal to 15°. The quantity, the thicknesses, and materials of the alternating layers of the first and second layered films are configured so that the window has an average reflectance, calculated throughout the visible spectrum, for light normally incident on the first layered film, of less than or equal to 10%. As a result, the window, when viewed from the first layered film, may have a relatively neutral appearance, with CIELAB a* and b* values of greater than or equal to −6.0 and less than or equal to 6.0, a and CIELAB L* value of less than or equal to 50.

As such, the windows described herein provide durable anti-reflection performance for a desired wavelength range of interest from 1400 nm to 1600 nm, while providing high transmission in the visible spectrum. Such high transmission in the visible spectrum may provide the windows with a transparent appearance. Moreover, additional sensors may be incorporated into the LIDAR system, which may be configured to detect radiation at wavelengths within the visible spectrum (e.g., cameras or other suitable form of imaging system). The relatively high transmission in the visible spectrum described herein beneficially facilitates the additional sensors generating high quality signals (e.g., with relatively high signal-to-noise ratios) to facilitate providing feedback into a system incorporating the LIDAR system (e.g., an autonomous driving system). The windows described herein thus provide durable, damage resistant covers for enclosures containing multiple sensors operating in distinct wavelength ranges of interest. Such properties may facilitate the construction of compact multi-sensor assemblies.

In further aspects, one or more of the layered films described herein may be disposed on a cover glass for a mobile device. Accordingly, the term “window,” as used herein, may also refer to a cover glass used in a mobile electronic device (e.g., a smartphone, tablet, smart watch, or other mobile computing device). In embodiments, for example, a cover glass may include a single layered film described herein, though embodiments are also envisioned where the cover glass includes multiple layered films (e.g., dispose don each major surface of the cover glass). In embodiments, a cover glass may include a single layered film disposed on a major surface thereof. The single layered film may include alternating layers of one or more lower refractive index materials and one or more higher refractive index materials, including a scratch resistant layer, as described herein. The quantity, material, and thickness of the layers of the layered film may be selected such that the cover glass has a maximum hardness, measured into the layered film and by the Berkovich Intender Hardness Test, of at least 10 GPa, an average percentage transmittance, calculated over a 50 nm wavelength range of interest surrounding a central wavelength between 1200 nm and 1600 nm, of greater than 85% for light incident on the layered film at angles of incidence of less than or equal to 15°, an average reflectance, calculated over the 50 nm wavelength range of interest between 1200and 1600 nm, of less than 4.5% (e.g., less than or equal to 4%, less than 3%, less than 2%, less than 1%, less than 0.5%) for light incident on the layered film at angles of less than or equal to 15°, and an average percentage transmission, calculated from 400 nm to 700 nm, of greater than 75% for light incident on the first surface and the second surface at angles of incidence of less than or equal to 15°. Such a cover glass may beneficially facilitate multi-wavelength range operation of various components of mobile devices (e.g., displays, cameras, touch panels, infrared or LIDAR sensors, other sensing or input components) that may be protected by the cover glass.

Unless otherwise noted, the total, specular, and average reflectance values provided herein are two-surface reflectance values, representing a total reflectance of an entire window, including the reflectance associated with each material interface in the window (e.g., between air and the layered films, between the layered films and the substrate, etc.). Unless otherwise noted, reflectance values provided in the infrared are measured from the side of the second layered film described herein (e.g., from the side positioned facing a sensor and emitter of a LIDAR system) and reflectance values provided in the visible are measured from the side of the first layered film described herein (e.g., from the side positioned facing an external environment of a LIDAR system).

Unless otherwise noted, the total, specular, and average transmittance values provided herein are two-surface transmittance values, representing a total transmission of the entire window (e.g., through a first layered film, a substrate, and a second layered film, if present). The terms “transmittance” and “transmission,” when used to describe the optical properties of a layer or stack of layers, are used interchangeably herein.

Unless otherwise specified herein, average transmittance and reflectance values are calculated using percentage reflectance and transmittance values at a plurality of wavelengths uniformly distributed throughout a specified wavelength range, including the endpoints of the range.

Unless otherwise noted herein, CIELAB color space a* and b* and lightness L* values are measured using a D65 illuminate for a standard observer with a 10-degree field of view.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “formed from” can mean one or more of comprises, consists essentially of, or consists of. For example, a component that is formed from a particular material can comprise the particular material, consist essentially of the particular material, or consist of the particular material.

As also used herein, the terms “article,” “glass-article,” “ceramic-article,” “glass-ceramics,” “glass elements,” “glass-ceramic article” and “glass-ceramic articles” may be used interchangeably, and in their broadest sense, to include any object made wholly or partly of glass and/or glass-ceramic material.

The term “disposed” is used herein to refer to a layer or sub-layer that is coated, deposited, formed, or otherwise provided onto a surface. The term disposed can include layers/sub-layers provided in direct contact with adjacent layers/sub-layers or layers/sub-layers separated by intervening material which may or may not form a layer.

The “central wavelength” is used herein to refer to a wavelength of light that is a peak operating wavelength of a sensor or light emitter in a sensor system (e.g., a LIDAR system). In embodiments, the central wavelength may correspond to a maximum frequency amplitude output by a radiation emitter in a sensor system. In embodiments, the central wavelength may correspond to a wavelength at which an article is measured to have a maximum transmittance.

Unless otherwise noted herein, refractive indices of the materials described herein are measured at 1550 nm.

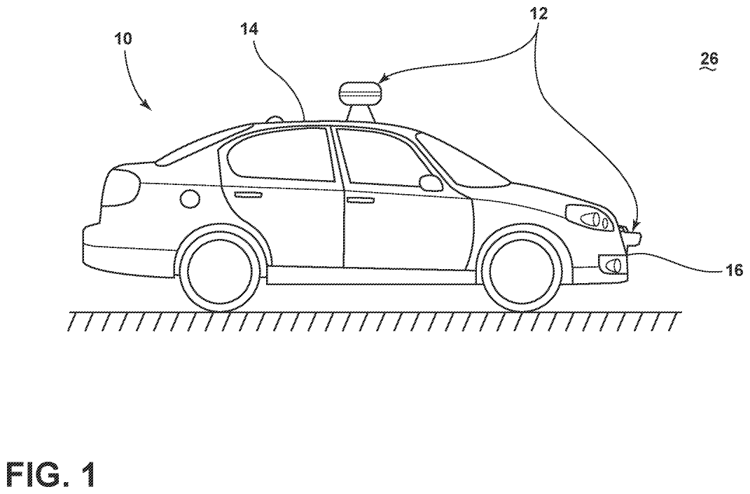

Referring now to FIG. 1, a vehicle 10 includes one or more LIDAR systems 12. The one or more LIDAR systems 12 can be disposed anywhere on or within the vehicle 10. For example, the one or more LIDAR systems 12 can be disposed on a roof 14 of the vehicle 10 and/or a forward portion 16 of the vehicle 10.

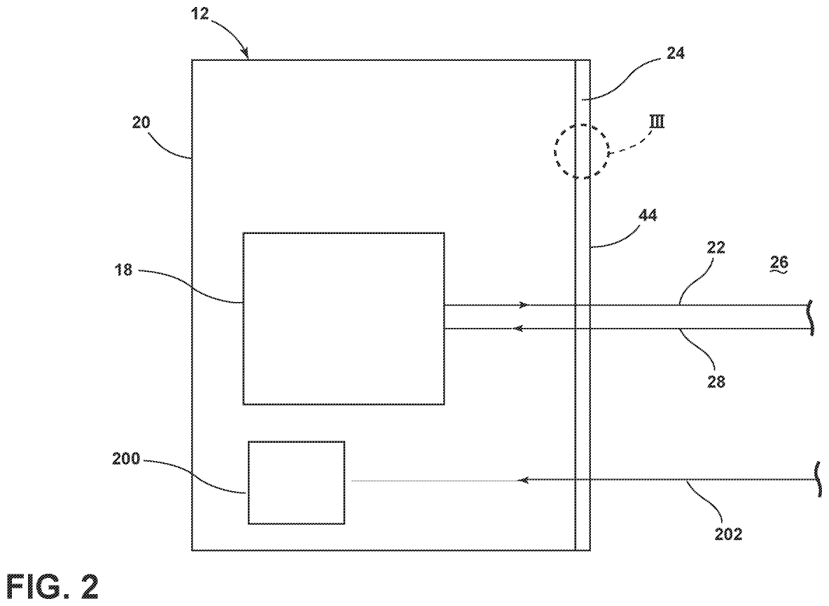

Referring now to FIG. 2, each of the one or more LIDAR systems 12 includes an electromagnetic radiation emitter and sensor 18 which may be enclosed in an enclosure 20. The electromagnetic radiation emitter and sensor 18 emits electromagnetic radiation 22 having a wavelength or range of wavelengths. The emitted radiation 22 exits the enclosure 20 through a window 24, which is in the path of the emitted electromagnetic radiation. If an object (not illustrated) in an external environment 26 is in the path of the emitted radiation 22, the emitted radiation 22 will reflect off of the object and return to the electromagnetic radiation emitter and sensor 18 as reflected radiation 28. The reflected radiation 28 again passes through the window 24 to reach the electromagnetic radiation emitter and sensor 18. In embodiments, the emitted radiation 22 and the reflected radiation 28 may include light within a suitable primary wavelength range of interest. For example, in embodiments, the emitted radiation 22 and reflected radiation 28 may be greater than or equal to 1400 nm and less than or equal to 1600 nm (e.g., greater than or equal to 1500 nm and less than or equal to 1600 nm, greater than or equal to 1525 nm and less than or equal to 1575 nm, approximately 1550 nm, 1550 nm). In embodiments, the emitted radiation 22 and reflected radiation 28 may lie within 50 nm of a central wavelength of the LIDAR system 12, and the central wavelength may be greater than or equal to 1400 nm and less than or equal to 1600 nm (e.g., equal to 1550 nm).

As shown in FIG. 2, in embodiments, each one of the one or more LIDAR systems 12 includes one or more additional sensors 200. The one or more additional sensors 200 are also disposed in the enclosure 12 and protected by the window 24 from external debris. In embodiments, the one or more additional sensors 200 operate in a suitable secondary wavelength range of interest that is distinct from the primary wavelength range of interest associated with the radiation emitter and sensor 18. For example, the one or more additional sensors 200 may include a detector (e.g., a charged coupled device or a complementary metal-oxide semiconductor device, a pixel array) and suitable structure (e.g., include optical filters or the like) that render the one or more additional sensors sensitive to incoming radiation 202 in the secondary wavelength range of interest. The secondary wavelength range of interest may have an upper wavelength that is at least 400 nm (e.g., 450 nm, 500 nm, 550 nm, 600 nm, 650 nm, 700 nm) less than a lower wavelength of the primary wavelength of interest associated with the radiation emitter and sensor 18. For example, in embodiments, the one or more additional sensors 200 may include imaging circuitry configured to generate images of the external environment 26 using light from the visible spectrum. The one or more additional sensors 200 may include a camera configured to generate a video signal in accordance with a suitable protocol or standard. In embodiments, the secondary wavelength range of interest may extend from 400 nm to 700 nm. Other secondary wavelength ranges of interest are contemplated and within the scope of the present disclosure. For example, any sub-portion of the visible spectrum may comprise the secondary wavelength range of interest. Moreover, secondary wavelength ranges of interest in the UV (e.g., from 300 nm to 400 nm) and near infrared (e.g., from 800 to 1100 nm) are also contemplated and within the scope of the present disclosure.

The incoming radiation 202 is depicted to originate from the external environment 26 (e.g., as sunlight scattered or reflected from an object) and propagate through the window 24 to the one or more additional sensors 200. While only incoming radiation 202 is depicted in FIG. 2, it should be understood that embodiments are also envisioned where the window 24 provides the performance attributes in the secondary wavelength range of interest for light initially emitted by the one or more additional sensors 200. For example, the one or more additional sensors 200 may include another sensor/emitter combination and operate as a LIDAR system within the secondary wavelength range of interest. The particular mode of operation of the one or more additional sensors 200 is not particularly limiting.

To facilitate the one or more additional sensors 200 generating high quality signals, the window 24 may be configured to provide a relatively high transmittance and low reflectance in the secondary wavelength range of interest.

The “visible spectrum” is the portion of the electromagnetic spectrum that is visible to the human eye and generally refers to electromagnetic radiation having a wavelength within the range of about 380 nm or 400 nm to about 700 nm. The “ultraviolet range” is the portion of the electromagnetic spectrum having wavelengths between about 10 nm and about 400 nm. The “infrared range” of the electromagnetic spectrum begins at about 700 nm and extends to longer wavelengths. The sun generates solar electromagnetic radiation, commonly referred to as “sunlight,” having wavelengths that fall within all three of those ranges.

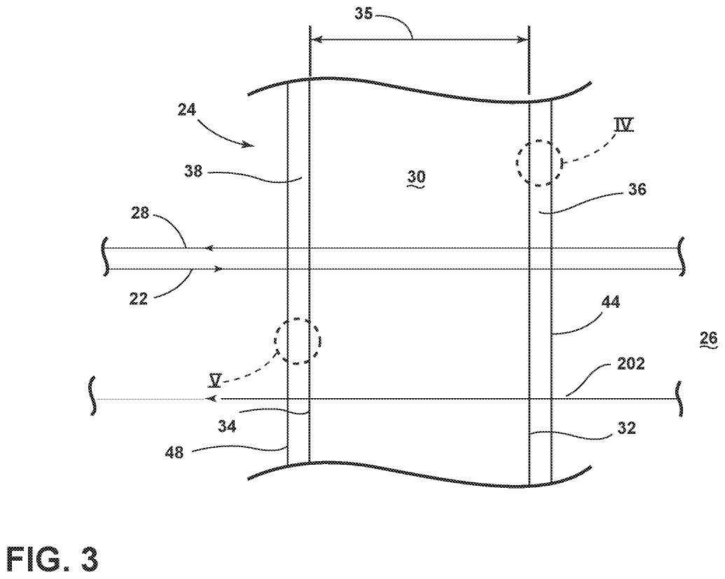

Referring now to FIG. 3, the window 24 for each of the one or more LIDAR systems 12 includes a substrate 30. The substrate 30 includes a first surface 32 and a second surface 34. The first surface 32 and the second surface 34 are the primary surfaces of the substrate 30. The first surface 32 is closest to the external environment 26. The second surface 34 is closest to the electromagnetic radiation emitter and sensor 18. The emitted radiation 22 encounters the second surface 34 before the first surface 32. The reflected radiation 28 in the primary wavelength range of interest encounters the first surface 32 before the second surface 34. The incoming radiation 202 in the secondary wavelength range of interest also encounters the first surface 32 before the second surface 34. The substrate 30 further includes a first layered film 36 disposed on the first surface 32 of the substrate 30 and a second layered film 38 disposed on the second surface 34 of the substrate 30. It should be understood that the window 24 as described herein is not limited to vehicular applications, and can be used for whatever application the window 24 would be useful to provide improved impact and optical performance, as described further herein.

The substrate 30 may be constructed from a variety of different materials in accordance with the present disclosure. In embodiments, the substrate 30 may be constructed of any type of glass, a glass ceramic, ceramic, and suitable polymer-based material. Various example structures and compositions of the substrate 30 are now described in greater detail.

In embodiments, the substrate 30 includes a glass composition or is a glass article. The substrate 30, for example, can include a borosilicate glass, an aluminosilicate glass, soda-lime glass, chemically strengthened borosilicate glass, chemically strengthened aluminosilicate glass, or chemically strengthened soda-lime glass. In embodiments, the glass composition of the substrate 30 is capable of being chemically strengthened by an ion-exchange process. In embodiments, the composition may be free of lithium ions.

An alkali aluminosilicate glass composition suitable for the substrate 30 comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio (Al₂O₃+B₂O₃)/Σ_{modifiers} (i.e., sum of modifiers) is greater than 1, wherein the ratio of the components are expressed in mol. % and the modifiers are alkali metal oxides. This composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio (Al₂O₃+B₂O₃)/Σ_{modifiers} (i.e., sum of modifiers) is greater than 1.

Another suitable alkali aluminosilicate glass composition for the substrate 30 comprises; 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein; 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)−Al₂O₃≤2 mol. %; 2 mol. % ≤Na₂O−Al₂O₃≤6 mol. %; and 4 mol. %≤(Na₂O+K₂O)−Al₂O₃≤10 mol. %.

Another suitable alkali aluminosilicate glass composition for the substrate 30 comprises; 2 mol. % or more of Al₂O₃ and/or ZrO₂, or 4 mol. % or more of Al₂O₃ and/or ZrO₂.

One example glass composition comprises SiO₂, B₂O₃, and Na₂O, where (SiO₂+B₂O₃)≥66 mol. %, and Na₂O≥9 mol. %. In an embodiment, the composition includes at least 6 wt. % aluminum oxide. In a further embodiment, the composition of one or more alkaline earth oxides, such as a content of alkaline earth oxides, is at least 5 wt. %. Suitable compositions, in some embodiments, further comprise at least one of K₂O, MgO, and CaO. In a particular embodiment, the composition of the substrate 30 comprises 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example composition suitable for the substrate 30 comprises; 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

A still further example glass composition suitable for the substrate 30 comprises; 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+NazO+K₂O)≤18 mol. % and 2 mol. %≤(MgO+CaO)≤7 mol. %.

The substrate 30 may be substantially planar or sheet-like, although other embodiments may utilize a curved or otherwise shaped or sculpted substrate. The length and width of the substrate 30 can vary according to the dimensions required for the window 24. The substrate 30 can be formed using various methods, such as float glass processes and down-draw processes such as fusion draw and slot draw. The substrate 30 can be used in a non-strengthened state. A commercially available example of a suitable non-strengthened substrate 30 for the window 24 is Corning® glass code 2320, which is a sodium aluminosilicate glass substrate.

The glass forming the substrate 30 can be modified to have a region contiguous with the first surface 32 and/or a region contiguous with the second surface 34 to be under compressive stress (“CS”). In such a circumstance, the region(s) under compressive stress extends from the first surface 32 and/or the second surface 34 to a depth(s) of compression. This generation of compressive stress further creates a central region that is under a tensile stress, having a maximum value at the center of the central region, referred to as central tension or center tension (CT). The central region extends between the depths of compression, and is under tensile stress. The tensile stress of the central region balances or counteracts the compressive stresses of the regions under compressive stress. As used herein, the terms “depth of compression” and “DOC” refer to the depth at which the stress within the substrate 30 changes from compressive to tensile stress. At the depth of compression, the stress crosses from a positive (compressive) stress to a negative (tensile) stress and thus has a value of zero. The depth of compression protects the substrate 30 from the propagation of flaws introduced by sharp impact to the first and/or second surfaces 32, 34 of the substrate 30, while the compressive stress minimizes the likelihood of a flaw growing and penetrating through the depths of compression. In embodiments, the depths of compression are each at least 20 μm. In embodiments, the absolute value of the maximum compressive stress CS within the regions is at least 200 MPa, at least about 400 MPa, at least 600 MPa, or up to about 1000 MPa.

Two methods for extracting detailed and precise stress profiles (stress as a function of depth) for a substrate 30 with regions under compressive stress are disclosed in U.S. Pat. No. 9,140,543, entitled “Systems and Methods for Measuring the Stress Profile of Ion-Exchanged Glass,” filed by Douglas Clippinger Allan et al. on May 3, 2012, and claiming priority to U.S. Provisional Patent Application No. 61/489,800, having the same title, and filed on May 25, 2011, the contents of which are incorporated herein by reference in their entirety.

In embodiments, generating the region(s) of the substrate 30 under compressive stress includes subjecting the substrate 30 to an ion-exchange chemical tempering process (chemical tempering is often referred to as “chemical strengthening”). In the ion-exchange chemical tempering process, ions at or near the first and second surfaces 32, 34 of the substrate 30 are replaced by-or exchanged with-larger ions usually having the same valence or oxidation state. In those embodiments in which the substrate 30 comprises, consists essentially of, or consists of an alkali aluminosilicate glass, an alkali borosilicate glass, an alkali aluminoborosilicate glass, or an alkali silicate glass, ions in the surface layer of the glass and the larger ions are monovalent alkali metal cations, such as Nat (when Lit is present in the glass), K⁺, Rb⁺, and Cs⁺. Alternatively, monovalent cations in, at, or near the first and second surfaces 32, 34 may be replaced with monovalent cations other than alkali metal cations, such as Ag⁺ or the like.

In embodiments, the ion-exchange process is carried out by immersing the substrate 30 in a molten salt bath containing the larger ions to be exchanged with the smaller ions in the substrate 30. It will be appreciated by those skilled in the art that parameters for the ion-exchange process, including, but not limited to, bath composition and temperature, immersion time, the number of immersions of the glass in a salt bath (or baths), use of multiple salt baths, and additional steps such as annealing, washing and the like, are generally determined by the composition of the substrate 30 and the desired depths of compression and compressive stress of the substrate 30 that result from the strengthening operation. By way of example, ion-exchange of alkali metal-containing glass substrates may be achieved by immersion in at least one molten bath containing a salt such as, but not limited to, nitrates, sulfates, and chlorides of the larger alkali metal ion. In embodiments, the molten salt bath comprises potassium nitrate (0-100 wt %), sodium nitrate (0-100 wt %), and lithium nitrate (0-12 wt %), the combined potassium nitrate and sodium nitrate having a weight percentage within the range of 88 wt % to 100 wt %. In embodiments, the temperature of the molten salt bath typically is in a range from about 350° C. up to about 500° C., while immersion times range from about 15 minutes up to about 40 hours, including from about 20 minutes to about 10 hours. However, temperatures and immersion times different from those described above may also be used. The substrate 30 may be acid polished or otherwise treated to remove or reduce the effect of surface flaws.

In some embodiments, the substrate 30 includes a glass-ceramic material having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite. “Glass-ceramics” include materials produced through controlled crystallization of glass. Examples of suitable glass-ceramics may include Li2O—Al2O3-SiO2 system (i.e., LAS-System) glass-ceramics, MgO—Al2O3-SiO2 system (i.e., MAS-System) glass-ceramics, ZnO×Al2O3×nSiO2 (i.e., ZAS system), and/or glass-ceramics that include a predominant crystal phase including β-quartz solid solution, β-spodumene, cordierite, and lithium disilicate. The glass-ceramic substrates may be strengthened using a chemical strengthening process.

In embodiments, the substrate 30 includes a ceramic material such as inorganic crystalline oxides, nitrides, carbides, oxy nitrides, carbo nitrides, and/or the like. Illustrative ceramics include those materials having an alumina, aluminum titanate, mullite, cordierite, zircon, spinel, perovskite, zirconia, ceria, silicon carbide, silicon nitride, silicon aluminum oxynitride, or zeolite phase.

In embodiments, the substrate 30 includes an organic or suitable polymeric material. Examples of suitable polymers include, without limitation: thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins (PO) and cyclicpolyolefins (cyclic-PO), polyvinylchloride (PVC), acrylic polymers including polymethyl methacrylate (PMMA) (including copolymers and blends), thermoplastic urethanes (TPU), polyetherimide (PEI) and blends of these polymers with each other. Other exemplary polymers include epoxy, styrenic, phenolic, melamine, and silicone resins.

In embodiments, the substrate 30 includes a plurality of layers or sub-layers. The layers or sub-layers of the substrate may be the same or different from one another. In embodiments, for example, the substrate 30 comprises a glass laminate structure. In embodiments, the glass laminate structure comprises a glazing comprises a first pane and a second pane attached to one another via a suitable interlayer (e.g., a polymer interlayer) disposed between the first pane and the second pane. In embodiments, the glass laminate structure comprises a glass-on-glass laminate structure formed via, for example, the fusion draw process. Glass-polymer laminates are also contemplated and within the scope of the present disclosure. Any material capable of meeting the optical requirements described herein may be used as the substrate 30.

In embodiments, the substrate 30 exhibits an elastic modulus (or Young's modulus) in the range from about 30 GPa to about 120 GPa. In some instances, the elastic modulus of the substrate may be in the range from about 30 GPa to about 110 GPa, from about 30 GPa to about 100 GPa, from about 30 GPa to about 90 GPa, from about 30 GPa to about 80 GPa, from about 30 GPa to about 70 GPa, from about 40 GPa to about 120 GPa, from about 50 GPa to about 120 GPa, from about 60 GPa to about 120 GPa, from about 70 GPa to about 120 GPa, and all ranges and sub-ranges therebetween.

In embodiments, the substrate 30 exhibits an average transmittance over the visible wavelength regime of about 85% or greater, about 86% or greater, about 87% or greater, about 88% or greater, about 89% or greater, about 90% or greater, about 91% or greater or about 92% or greater. In embodiments, the substrate 30 comprises a tinting component (e.g., tinting layer or additive) and may optionally exhibit a color, such as white, black, red, blue, green, yellow, orange etc.

As depicted in FIG. 3, the substrate 30 has a thickness 35 defined as the shortest straight-line distance between the first surface 32 and the second surface 34. In embodiments, the thickness 35 of the substrate 30 is between about 100 μm and about 5 mm. In embodiments, the substrate 30 can have a physical thickness 35 ranging from about 100 μm to about 500 μm (e.g., 100, 200, 300, 400, or 500 μm). In other embodiments, the thickness 35 ranges from about 500 μm to about 1000 μm (e.g., 500, 600, 700, 800, 900, or 1000 μm). The thickness 35 may be greater than about 1 mm (e.g., about 2, 3, 4, 5 mm, 6 mm, or 7 mm). In one or more specific embodiments, the thickness 35 is 2 mm or less or less than or equal to 1 mm.

In embodiments, the thickness 35 is uniform (e.g., varies by less than 1% throughout an entirety of the substrate) such that the substrate 35 is in the form of a planar sheet. In embodiments, the thickness 35 is a variable thickness and has a value that varies as a function of position on the substrate 30. The thickness 35 may vary along one or more of its dimensions for aesthetic and/or functional reasons. For example, the edges of the substrate 30 may be thicker as compared to more central regions of the substrate 30. The length, width and physical thickness dimensions of the substrate 30 may also vary according to the application or use of the article 30.

In embodiments, the substrate 30 includes a visible light absorbing, IR-transmitting material layer. Examples of such materials include infrared transmitting, visible absorbing acrylic sheets, such as those commercially available from ePlastics under the trade names Plexiglas® IR acrylic 3143 and CYRO's ACRYLITE® IR acrylic 1146. Plexiglas® IR acrylic 3143 has a transmissivity of about 0% (at least less than 10%, or less than 1%) for electromagnetic radiation having wavelengths of about 700 nm or shorter, but a transmissivity of about 90% (above 85%) for wavelengths within the range of 800 nm to about 1100 nm (including 905 nm).

In embodiments, the substrate 30 exhibits a refractive index in the range from about 1.45 to about 1.55. In embodiments, the substrate exhibits an average transmission of greater than or equal to 95% (e.g., greater than or equal to 96%, greater than or equal to 97%, greater than or equal to 98%, greater than or equal to 99%) throughout a spectral range from 1400 nm to 1600 nm.

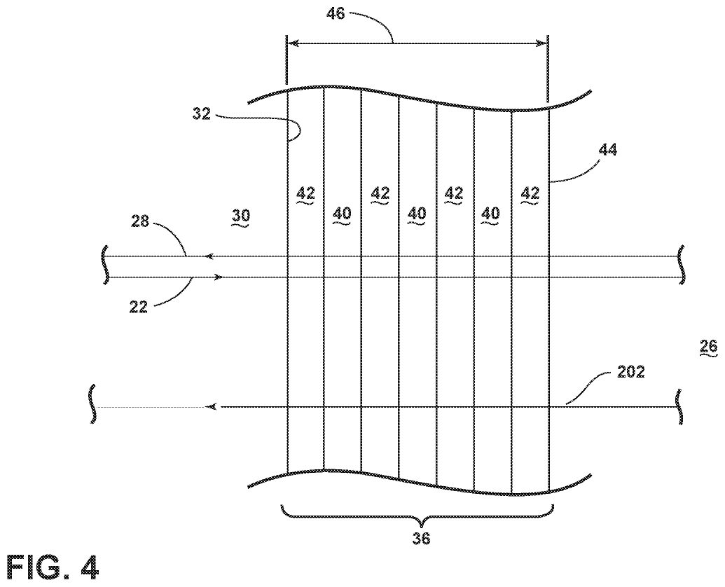

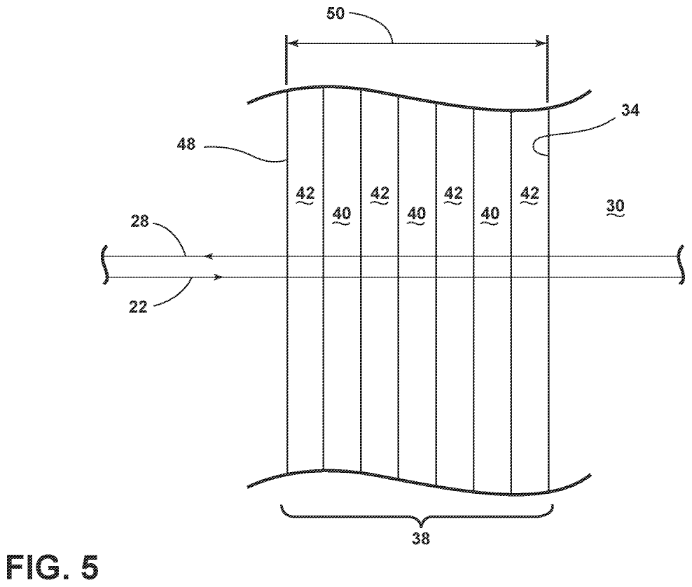

Referring now to FIGS. 4 and 5, the first layered film 36 and the second layered film 38 each include a quantity of alternating layers of one or more higher refractive index materials 40 and one or more lower refractive index materials 42. While each of the one or more higher refractive index materials 40 and the one or more lower index materials 42 are identified using the same reference numerals, it should be understood that the utilization of the same reference numeral does not indicate that each of the layers are constructed of the same material or include the same structure. In each of the first and second layered films 36 and 38, different ones of the layers of the respective higher refractive index material 40 and the layers of the lower refractive index materials 42 may include different compositional or structural properties.

As used herein, the terms “higher refractive index” and “lower refractive index” refer to the values of the refractive index relative to each other, with the refractive index/indices of the one or more higher refractive index materials 40 being greater than the refractive index/indices of the one or more lower refractive index materials 42. In embodiments, the one or more higher refractive index materials 40 have a refractive index from about 1.7 to about 4.0. In embodiments, the one or more lower refractive index materials 42 have a refractive index from about 1.3 to about 1.6. In embodiments, the one or more lower refractive index materials 42 have a refractive index from about 1.3 to about 1.7, while the one or more higher refractive index materials 40 have a refractive index from about 1.9 to about 3.8. The difference in the refractive index of any of the one or more higher refractive index materials 40 and any of the one or more lower refractive index materials 42 may be about 0.1 or greater, 0.2 or greater, 0.3 or greater, 0.4 or greater, 0.5 or greater, 0.6 or greater, 0.7 or greater, 0.8 or greater, 0.9 or greater, 1.0 or greater, 1.5 or greater, 2.0 or greater, 2.1 or greater, 2.2 or greater, or even 2.3 or greater. Because of the difference in the refractive indices of the one or more higher refractive index materials 40 and the one or more lower refractive index materials 42, manipulation of the quantity (number) of alternating layers and their thicknesses can cause selective transmission of electromagnetic radiation within a range of wavelengths through the window 24 and, separately, selective reflectance of electromagnetic radiation within a range of wavelengths off of the first layered film 36. The first layered film 36 (and the second layered film 38, if utilized) is thus a thin-film optical filter having predetermined optical properties configured as a function of the quantity, thicknesses, and materials chosen as the one or more higher refractive index materials 40 and the one or more lower refractive index materials 42.

Some examples of suitable materials for use as the one or more lower refractive index materials 42 include SiO₂, Al₂O₃, GeO₂, SiO, AlOₓN_{y}, SiOₓN_{y}, SiᵤAlᵥOₓN_{y}, MgO, MgAl₂O₄, MgF₂, BaF₂, CaF₂, DyF₃, YbF₃, YF₃, and CeF₃. The nitrogen content of the materials for use as the one or more lower refractive index materials 42 may be minimized (e.g., in materials such as AlOₓN_{y}, SiOₓN_{y}, and SiᵤAlᵥOₓN_{y}).

Some examples of suitable materials for use as the one or more higher refractive index materials 40 include Si, amorphous silicon (a-Si), SiNₓ, SiNₓ:H_{y}, AlNₓ, SiᵤAlᵥOₓN_{y}, Ta₂O₅, Nb₂O₅, AlN, Si₃N_{y}, AlOₓN_{y}, SiOₓN_{y}, HfO₂, TiO₂, ZrO₂, Y₂O₃, Al₂O₃, MoO₃, and diamond-like carbon. The oxygen content of the materials for the higher refractive index material 40 may be minimized, especially in SiNₓ or AlNₓ materials. AlOₓN_{y} materials may be considered to be oxygen-doped AlNₓ, that is they may have an AlNₓ crystal structure (e.g., wurtzite) and need not have an AlON crystal structure. Exemplary preferred AlOₓN_{y} materials for use as the one or more higher refractive index materials 40 may comprise from about 0 atom % to about 20 atom % oxygen, or from about 5 atom % to about 15 atom % oxygen, while including 30 atom % to about 50 atom % nitrogen. Exemplary preferred SiᵤAlᵥOₓN_{y} for use as the one or more higher refractive index materials 40 may comprise from about 10 atom % to about 30 atom % or from about 15 atom % to about 25 atom % silicon, from about 20 atom % to about 40 atom % or from about 25 atom % to about 35 atom % aluminum, from about 0 atom % to about 20 atom % or from about 1 atom % to about 20 atom % oxygen, and from about 30 atom % to about 50 atom % nitrogen. The foregoing materials may be hydrogenated up to about 30% by weight. Because the refractive indices of the one or more higher refractive index materials 40 and the one or more lower refractive index materials 42 are relative to each other, the same material (such as Al₂O₃) can be appropriate for the one or more higher refractive index materials 40 depending on the refractive index of the material(s) chosen for the one or more lower refractive index materials 42, and can alternatively be appropriate for the one or more lower refractive index materials 42 depending on the refractive index of the material(s) chosen for the one or more higher refractive index material 40.

In embodiments, the one or more lower refractive index materials 42 of the first layered film 36 consists of layers of SiO₂, and the one or more higher refractive index materials 40 of the first layered film 36 consists of layers of SiOₓN_{y} or SiNₓ. In embodiments, the one or more lower refractive index materials 42 of the second layered film 38 consists of layers of SiO₂, and the one or more higher refractive index materials 40 of the second layered film 38 consists of layers of SiOₓN_{y} or SiNₓ.

The quantity of alternating layers of the higher refractive index material 40 and the lower refractive index material 42 in either the first layered film 36 or the second layered film 38 is not particularly limited. In embodiments, the number of alternating layers within the first layered film 36 is 7 or more, 9 or more, 11 or more, 13 or more, 15 or more, 17 or more, 19 or more, 21 or more, 23 or more, 25 or more, or 51 or more, or 81 or more. In embodiments, the quantity of alternating layers within the second layered film 38 is 7 or more, 9 or more, 11 or more, 13 or more, 15 or more, 17 or more, 19 or more, 21 or more, 23 or more, or 25 or more. In embodiments, the quantity of alternating layers in the first layered film 36 and the second layered film 38 collectively forming the window 24, not including the substrate 30, is 14 or more, 20 or more, 26 or more, 32 or more, 38 or more, 44 or more, 50or more, 72 or more, or 100 or more. In general, the greater the quantity of layers within the first layered film 36 and the second layered film 38, the more narrowly the transmittance and reflectance properties of the window 24 are tailored to one or more specific wavelengths or wavelength ranges.

Each of the alternating layers of the first layered film 36 and the second layered film 38 has a thickness. The thicknesses selected for each of the alternating layers determines the optical path lengths of light propagating through the window 24 and determines the constructive and destructive interference between different light rays reflected at each interface of the window 24. Accordingly, the thicknesses of each of the alternating layers, in combination with the refractive index of the one or more higher refractive index materials 40 and the one or more lower refractive index materials 42 determines the reflectance and transmittance spectra of the window 24.

In embodiments, each layer of the alternating layers of the lower refractive index materials 42 and the higher refractive index materials 40 can have a physical thickness that ranges from about 5 nm to 2000 nm, about 5 nm to 1500 nm, about 5 nm to 1000 nm, and all thicknesses and ranges of thickness between these values. For example, the layers of the higher refractive index materials 40 can have a physical thickness of 5 nm, 10 nm, 20 nm, 30 nm, 40 nm, 50 nm, 60 nm, 70 nm, 80 nm, 90 nm, 100 nm, 250 nm, 500 nm, 750 nm, 1000 nm, 1250 nm, 1500 nm, 1750 nm, 2000 nm and all thickness values between these levels. Further, each of the layers of the higher refractive index materials 40 of the second layered film 38 can have a physical thickness that ranges from about 5 nm to 500 nm, about 5 nm to 400 nm, about 5 nm to 300 nm, and all thicknesses and ranges of thickness between these values. As an example, each of the layers of the higher refractive index materials 40 can have a physical thickness of 5 nm, 10 nm, 20 nm, 30 nm, 40 nm, 50 nm, 60 nm, 70 nm, 80nm, 90 nm, 100 nm, 200 nm, 300 nm, 400 nm, 500 nm, and all thickness values between these levels. In addition, the layers of the lower refractive index materials 42 in the first and second layered films 36 and 38 can have a physical thickness from about 5 nm to 500 nm, about 5 to 400 nm,, about 5 to 300 nm about 5 nm to 250 nm, about 5 nm to 200 nm, and all thicknesses and ranges of thickness between these values. For example, each of the layers of the one or more lower refractive index materials 42 in the first and second films 36 and 38 can have a physical thickness of 5 nm, 10 nm, 20 nm, 30 nm, 40 nm, 50 nm, 60 nm, 70 nm, 80 nm, 90 nm, 100 nm, 150 nm, 200 nm, 250 nm, 300 nm, 400 nm, 450 nm and all thickness values between these levels.

With reference to FIGS. 3, 4, and 5, the reflected radiation 28 and the incoming radiation 202 first encounters a terminal surface 44 of the first layered film 36 upon interacting with the window 24, and the terminal surface 44 may be open to the external environment 26. In an embodiment, a layer of the one or more lower refractive index materials 42 (or an additional layer disposed thereon) provides the terminal surface 44 to more closely match the refractive index of the air in the external environment 26 and thus reduce reflection of incident electromagnetic radiation (whether the reflected radiation 28 or otherwise) off of the terminal surface 44. The layer of the one or more lower refractive index materials 42 that provides the terminal surface 44 is the layer of the first layered film 36 that is farthest from the substrate 30. Similarly, in an embodiment, when the one or more lower refractive index materials 42 is SiO₂, a layer of SiO₂, as the one or more lower refractive index materials 42, is disposed directly onto the first surface 32 of the substrate 30, which will typically comprise a large mole percentage of SiO₂. Without being bound by theory, it is thought that commonality of SiO₂ in both the substrate 30 and the adjacent layer of the one or more lower refractive index materials 42 allows for increased bonding strength.

The emitted radiation 22 first encounters a terminal surface 48 of the second layered film 38 upon interacting with the window 24. In an embodiment, a layer of the one or more lower refractive materials 42 provides the terminal surface 48 to more closely match the refractive index of the air within the enclosure 20 and thus reduce reflection of the incident emitted radiation 22 off of the terminal surface 48. The layer of the one or more lower refractive index materials 42 that provides the terminal surface 48 is the layer of the second layered film 38 that is farthest from the substrate 30. Similarly, in an embodiment, when the one or more lower refractive index materials 42 is SiO₂, a layer of SiO₂, as the one or more lower refractive index materials 42, is disposed directly onto the second surface 34 of the substrate 30.

Materials that have a relatively high refractive index can simultaneously have a relatively high hardness that provides scratch and impact resistance. An example material that has both high hardness and can be one of the one or more higher refractive index material 40 is SiNₓ. Other example materials that have both high hardness and can be the higher refractive index material 40 are SiOₓN_{y}, SiNₓ:H_{y}, and Si₃N₄. It has been found that a relatively thick (e.g., greater than or equal to 500 nm) layer of SiNₓ (or other suitable higher refractive index material) may increase the scratch and/or damage resistance of the window 24. Such increased scratch and/or damage resistance may be particularly beneficial in the first layered film 36, which may be more likely to encounter impacts of debris from the external environment 26. Accordingly, in embodiments, the first layered film 36 comprises a layer of one of the one or more higher refractive index materials 40 with a thickness greater than or equal to 500 nm (e.g., greater than or equal to 1000 nm, greater than or equal to 1500 nm, greater than or equal to 2000 nm). Such a higher refractive index layer having such a thickness of 500 nm or more is described herein as a “scratch resistant layer.”

In embodiments, the scratch resistant layer may include or more materials chosen from SiᵤAlᵥOₓN_{y}, Ta₂O₅, Nb₂O₅, AlN, AlNₓ, SiAlₓN_{y}, AlN/SiAlₓN_{y}, Si₃N_{y}, AlOₓN_{y}, SiOₓN_{y}, SiNₓ, SiNₓ:H_{y}, HfO₂, TiO₂, ZrO₂, Y₂O₃, Al₂O₃, MoO₃, diamond-like carbon, or combinations thereof. Exemplary materials used in the scratch-resistant layer may include an inorganic carbide, nitride, oxide, diamond-like material, or combination thereof. Examples of suitable materials for the scratch-resistant layer include metal oxides, metal nitrides, metal oxynitride, metal carbides, metal oxycarbides, and/or combinations thereof. Exemplary metals include B, Al, Si, Ti, V, Cr, Y, Zr, Nb, Mo, Sn, Hf, Ta and W. Specific examples of materials that may be utilized in the scratch-resistant layer may include Al₂O₃, AlN, AlOₓN_{y}, Si₃N₄, SiOₓN_{y}, SiᵤAlᵥOₓN_{y}, diamond, diamond-like carbon, SiₓC_{y}, SiₓO_{y}C_{z}, ZrO₂, TiOₓN_{y}, and combinations thereof. In some implementations, the scratch-resistant layer may include Ta₂O₅, Nb₂O₅, SiNₓ, Al₂O₃, SiOₓN_{y}, AlNₓ, SiAlₓN_{y}, and combinations thereof. In further implementations, one or more of the scratch-resistant layers 150a, 150b may be a super-lattice of nano-layered AlNₓ/SiAlₓN_{y}, as detailed in U.S. Patent Application Publication No. 2018/0029929, published on Feb. 1, 2018, entitled “Optical Structures and Articles with Multilayer Stacks Having High Hardness and Methods for Making the Same”, the salient portions of which are hereby incorporated by reference in this disclosure. In embodiments, the scratch-resistant layer exhibits a fracture toughness value greater than about 1 MPa√m and simultaneously exhibits a hardness value greater than about 10 GPa, as measured by a Berkovich Hardness Test.

In embodiments, the scratch-resistant layer may comprise a compositional gradient. For example, the scratch resistant layer may include a compositional gradient of SiᵤAlᵥOₓN_{y} where the concentration of any one or more of Si, Al, O and N are varied to increase or decrease the refractive index. The refractive index gradient may also be formed using porosity. Such gradients are more fully described in U.S. Patent Application Publication No. 2014/0334006A1, published on Nov. 13, 2014, entitled “Scratch-Resistant Articles with a Gradient Layer”, which is hereby incorporated by reference in its entirety.

In embodiments, the thickness and location within the first layered film 36 of the scratch resistant layer can be optimized to provide a desired level of hardness and scratch resistance to the first layered film 36 and thus the window 24 as a whole. Different applications of the window 24 could lead to different desired thicknesses for the scratch resistant layer of the higher refractive index material 40 serving as the layer providing the hardness and scratch resistance to the window 24. For example, a window 24 protecting a LIDAR system 12 on a vehicle 10 may require a different thickness for the scratch resistant layer of the higher refractive index material 40 than a window 24 protecting a LIDAR system 12 at an office building. In embodiments, the scratch resistant layer of the higher refractive index material 40 serving as the layer providing the hardness and scratch resistance to the window 24 has a thickness between 500 nm and 50000 nm, such as between 500 nm and 10000 nm, such as between 2000 nm to 5000 nm. In embodiments, the thickness of this scratch resistant layer of higher refractive index material 40 has a thickness that is 50% or more, 65% or more, or 85% or more, or 86% or more, of the thickness of the first layered film 36. In general, the scratch resistant layer of the higher refractive index material 40 serving as the layer providing the hardness and scratch resistance to the window 24 will be part of the first layered film 36 facing the external environment 26 rather the second layered film 38 protected by the enclosure 20, although that may not always be so.

As will be detailed further below, the quantity, thicknesses, and materials of the remaining layers of the first layered film 36 and the second layered film 38 can be configured to provide the window 24 with the desired optical properties (transmittance and reflectance of desired wavelengths) almost regardless of the thickness chosen for the scratch resistant layer of the higher refractive index material 40 serving as the layer providing the hardness and scratch resistance to the window 24. This insensitivity of the optical properties of the window 24 as a whole to the thickness of the scratch resistant layer of the higher refractive index material 40 serving as the layer providing the hardness and scratch resistance to the window 24 when materials having relatively low or negligible optical absorption of electromagnetic radiation over the primary and secondary wavelength ranges of interest described herein (e.g., from 400 nm to 700 nm and from 1400 nm to 1600 nm). For example, Si₃N₄ only negligibly absorbs electromagnetic radiation in the 700 nm to 2000 nm wavelength range.

This general insensitivity allows the scratch resistant layer of the higher refractive index material 40 in the first layered film 36 to have a thickness predetermined to meet specified hardness or scratch resistance requirements. For example, the first layered film 36 for the window 24 utilized at the roof 14 of the vehicle 10 may have different hardness and scratch resistance requirements than the first layered film 36 for the window 24 utilized at the forward portion 16 of the vehicle 10, and thus a different thickness for the scratch resistant layer of the higher refractive index material 40. This can be achieved without significant altering of the transmittance and reflectance properties of the first layered film 36 as a whole.

The hardness of the first layered film 36, and thus the window 24, with the scratch resistant layer of the higher refractive index material 40 can be quantified. In some embodiments, the maximum hardness of the window 24, measured at the first layered film 36 with the scratch resistant layer of the higher refractive index material 40, as measured by the Berkovich Indenter Hardness Test, may be about 8 GPa or greater, about 10 GPa or greater, about 12 GPa or greater, about 14 GPa or greater, about 15 GPa or greater, about 16 GPa or greater, or about 18 GPa or greater at one or more indentation depths from 50 nm to 2000 nm (measured from the terminal surface 44), and even from 2000 nm to 5000 nm. As used herein, the “Berkovich Indenter Hardness Test” includes measuring the hardness of a material on a surface thereof by indenting the surface with a diamond Berkovich indenter. The Berkovich Indenter Hardness Test includes indenting the terminal surface 44 of the first layered film 36 with the diamond Berkovich indenter to form an indent to an indentation depth in the range from about 50 nm to about 2000 nm (or the entire thickness of the first layered film 36) and measuring the maximum hardness from this indentation along the entire indentation depth range or a segment of this indentation depth range (e.g., in the range from about 100 nm to about 600 nm), generally using the methods set forth in Oliver, W. C.; Pharr, G. M. An improved technique for determining hardness and elastic modulus using load and displacement sensing indentation experiments. J. Mater. Res., Vol. 7, No. 6, 1992, 1564-1583; and Oliver, W. C.; Pharr, G. M. Measurement of Hardness and Elastic Modulus by Instrument Indentation: Advances in Understanding and Refinements to Methodology. J. Mater. Res., Vol. 19, No. 1, 2004, 3-20. These levels of hardness improve the resistance of the window 24 to impact damage from sand, small stones, debris, and other objects encountered while the LIDAR system 12 is used for its intended purpose, such as with the vehicle 10 (see FIG. 1). Accordingly, these levels of hardness reduce or prevent the optical scattering and reduced performance of the LIDAR system 12 that the impact damage would otherwise cause.

In embodiments, the window 24 may exhibit a maximum hardness of about 10 GPa or greater, about 11 GPa or greater, or about 12 GPa or greater, as measured in the outer optical film structure 130a by a Berkovich Indenter Hardness Test over an indentation depth from about 100 nm to about 500 nm. For example, the window 24 can exhibit a maximum hardness of 10 GPa, 11 GPa, 12 GPa, 13 GPa, 14 GPa, 15 GPa, 16 GPa, 17 GPa, 18 GPa, 19 GPa, 20 GPa, or greater, as measured in the first layered film 36.

In embodiments, at least a portion of the first layered film 36 is disposed between the scratch resistant layer of the higher refractive index material 40 and the terminal surface 44. In embodiments, the first layered film 36 comprises a plurality of alternating layers of the one or more lower refractive index materials 42 and the one or more higher refractive index materials 40 between the terminal surface 44 and the scratch resistant layers. Such a stack of alternating layers disposed between the scratch resistant layer and the terminal surface 44 is described herein as the “optical control layers.” In embodiments, the optical control layers, disposed between the scratch resistant layer and the terminal surface 44, have a combined thickness of greater than or equal to 500 nm (e.g., greater than or equal to 600 nm, greater than or equal to 700 nm, greater than or equal to 800 nm, greater than or equal to 900 nm, greater than or equal to 1000 nm, greater than or equal to 1100 nm, greater than or equal to 1200 nm, greater than or equal to 1300 nm, greater than or equal to 1400 nm). The quantity, composition, and thickness of the optical control layers may be selected to provide desired anti-reflection performance attributes described herein at an operational wavelength of the LIDAR sensor 12 between 1400 nm and 1600 nm.

In embodiments, at least 25% (e.g., at least 26%, at least 27%, at least 28%, at least 29%, at least 30%) of a thickness 46 of the first layered film 36 is disposed between the scratch resistant layer and the terminal surface 44. It is believed that such a depth of the scratch resistant layer within the first layered film 36 facilitates the first layered film 36 having a relatively high nanoindentation hardness (as measured by the Berkovich Indenter Hardness Test) over a relatively large range of depths within the first layered film 36. In embodiments, the first layered film 36 has a nanoindentation hardness of greater than or equal to 8 from a depth of 250 nm to a depth of 2000 nm within the first layered film 36. In embodiments, the first layered film 36 has a nanoindentation hardness of greater than or equal to 8.5 from a depth of 1000 nm to a depth of 2000 nm within the first layered film 36. Such hardness values facilitate providing scratch and/or damage resistance against flaws having a relatively wide range of depths.

In one or more embodiments, the window 24 may include one or more additional top coatings (not depicted) disposed over one or more of the first layered film 36 and the second layered film 38. In embodiments, the top coatings may form the terminal surfaces 44 and 48. In one or more embodiments, the additional top coating may include an easy-to-clean coating. An example of a suitable an easy-to-clean coating is described in U.S. Application Publication No. 2014/0113083, published on Apr. 24, 2014, entitled “Process for Making of Glass Articles with Optical and Easy-to-Clean Coatings”, which is incorporated herein in its entirety by reference. The easy-to-clean coating may have a thickness in the range from about 5 nm to about 50 nm and may include known materials such as fluorinated silanes. The easy-to-clean coating may alternately or additionally comprise a low-friction coating or surface treatment. Exemplary low-friction coating materials may include diamond-like carbon, silanes (e.g., fluorosilanes), phosphonates, alkenes, and alkynes. In some embodiments, the easy-to-clean coating of the top coating may have a thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm, from about 7 nm to about 10 nm, from about 1 nm to about 90 nm, from about 5 nm to about 90 nm, from about 10 nm to about 90 nm, or from about 5 nm to about 100 nm, and all ranges and sub-ranges therebetween.

Referring now to FIGS. 4 and 5, the first layered film 36 has a thickness 46, and the second layered film 38 has a thickness 50. The thickness 46 of the first layered film 36, assumed to include the scratch resistant layer of the one or more higher refractive index materials 40, may be about 1 μm or greater while still providing the transmittance and reflectance properties described herein. In embodiments, the thickness 46 is in the range of 1 μm to just over 50 μm, including from about 1 μm to about 10 μm, and from about 2800 nm to about 5900 nm. The lower bound of about 1 μum is approximately the minimum thickness 46 that still provides hardness and scratch resistance to the window 24. The higher bound of thickness 46 is limited by cost and time required to dispose the layers of the first layered film 36 onto the substrate 30. In addition, the higher bound of the thickness 46 is limited to prevent the first layered film 36 from warping the substrate 30, which is dependent upon the thickness of the substrate 30. The thickness 50 of the second layered film 38 can be any thickness deemed necessary to impart the window 24 with the desired transmittance and reflectance properties. In embodiments, the thickness 50 of the second layered film 38 is in the range of about 800 nm to about 7000 nm.

While solving the problem discussed above in the background through imparting hardness, impact, and scratch resistance to the window 24 via the maximized thickness of a higher refractive index material 40, the quantity, thicknesses, and materials of the layers of the first layered film 36 and the second layered film are configured to also provide a relatively high transmittance of infrared radiation between 1400 nm and 1600 nm through the window 24. In embodiments, the thicknesses, and materials of the alternating layers of the first and second layered films 36 and 38 are configured so that the window 24 has an average percentage transmittance, calculated over a 50 nm wavelength range of interest surrounding a central wavelength (e.g., such that the central wavelength is equal to an average of an upper wavelength and a lower wavelength of the 50 nm wavelength range of interest) that is greater than or equal to 1400 nm and less than or equal to 1600 nm, of greater than or equal to 90% (e.g., greater than or equal to 91%, greater than or equal to 92%, greater than or equal to 93%, greater than or equal to 94%, greater than or equal to 95%) for light incident on the first surface 32 and the second surface 34 at angles within 15° of normal to the first surface 32 and the second surface 34. In embodiments, the thicknesses, and materials of the alternating layers of the first and second layered films 36 and 38 are configured so that the window 24 has an average reflectance, calculated over the 50 nm wavelength range of interest, of less than or equal to 0.5% (e.g., less than or equal to 0.4%, less than or equal to 0.3%, less than or equal to 0.2%) for light incident on the first surface 32 and the second surface 34 at angles within 15° of normal to the first surface 32 and the second surface 34. In embodiments, the number, thicknesses, and materials of the alternating layers of the first and second layered films 36 and 38 are configured so that the window 24 has an average P polarization transmittance and an average S polarization transmittance, calculated over a 50 nm wavelength range of interest from 1400 nm to 1600 nm, of greater than 85% (e.g., greater than or equal to 86%, greater than or equal to 87%, greater than or equal to 88%, greater than or equal to 89%, greater than or equal to 90%) for light incident on the first surface 32 and the second 34 surface at angles within 60° of normal (e.g., at angles of incidence from 0° to 60°, from 0° to 50°, from 0° to 40°, from 0° to 30°) to the first surface 32 and the second surface 34. Herein, the term “reflectance” is defined as the percentage of incident optical power within a given wavelength range that is reflected from a material (e.g., the window 24, the substrate 30, the first layered film 36, or portions thereof).

In embodiments, the thicknesses, and materials of the alternating layers of the first and second layered films 36 and 38 are configured so that the window 24 has an average percentage transmittance, calculated over the 50 nm wavelength range of interest surrounding the that is less than or equal to 1400 nm and greater than or equal to 1600 nm, of greater than or equal to 95% (e.g., greater than or equal to 95.5%, greater than or equal to 96%, greater than or equal to 96.5%, greater than or equal to 97.5%, greater than or equal to 98%, greater than or equal to 99%, greater than or equal to 99.5%) for light normally incident on the first surface 32 and the second surface 34. Herein, the term “transmittance” and “percentage transmission” are used interchangeably and refer to the percentage of incident optical power within a given wavelength range transmitted through a material (e.g., the window 24, the substrate 30, the first layered film 36, the second layered film 38 or portions thereof).

In embodiments, the thicknesses, and materials of the alternating layers of the first and second layered films 36 and 38 are configured so that the window 24 also (in addition to meeting the optical performance requirements in the infrared described herein) has a transparent and/or color-neutral appearance. For example, when viewed from the external environment 26 (see FIG. 1), the window 24 may exhibit CIELAB color space a* values that are greater than or equal to −6.0 and less than or equal to 6.0 (e.g., greater than or equal to −3.5 and less than or equal to 3.5, greater than or equal to −3.5 and less than or equal to 0.5) for light having angles of incidence on the first surface 32 ranging from 0° to 90°. The window 24 may also exhibit CIELAB color space b* values that are greater than or equal to −6.0 and less than or equal to 6.0 (e.g., greater than or equal to −3.5 and less than or equal to 3.5, greater than or equal to −3.5 and less than or equal to 0.5) for light having angles of incidence on the first surface 32 ranging from 0° to 90°. Such color space values are obtained even in embodiments where the substrate 30 is has a relatively high transmittance (e.g., greater than 90%) within the visible spectrum.

In embodiments, the thicknesses, and materials of the alternating layers of the first and second layered films 36 and 38 are configured so that the window 24 has a CIELAB lightness L* value of less than 50 when viewed from angles of incidence of less than or equal to 60°. In embodiments, the thicknesses, and materials of the alternating layers of the first and second layered films 36 and 38 are configured so that the window 24 has a CIELAB lightness L* value of less than 35 for light that is normally incident on the first layered film 36 and reflected. Such L* values may render the window 24 less noticeable when viewed from the external environment 26. Other embodiments, where the window 24 exhibits an L* value of greater than 50 (e.g., greater than 60), to provide the window 24 with an appearance of a mirror when viewed from the first layered film 36, are also contemplated and within the scope of the present disclosure.

In embodiments, the thicknesses, and materials of the alternating layers of the first and second layered films 36 and 38 are configured so that the window 24 has an average percentage transmittance of greater than or equal to 70% (e.g., greater than or equal to 80%, greater than or equal to 85%) for light in the visible spectrum that is incident on the first surface 32 or the second surface 34 at angles of incidence of 60° or less. In embodiments, the thicknesses, and materials of the alternating layers of the first and second layered films 36 and 38 are configured so that the window 24 has a transmittance of greater than 85% throughout at least a portion of the visible spectrum (e.g., from 450 nm to 700 nm, from 500 nm to 650 nm, from 500 nm to 600 nm, or any other suitable sub-portion of the visible spectrum) for light that is incident on the window 24 at angles of incidence of 45° or less. Such high transmission in the visible spectrum may facilitate the incoming radiation 202 reaching the one or more additional sensors 200 (see FIG. 2) with relatively low signal loss, and the one or more additions sensors 200 generating image signals with relatively low amounts of noise.

In embodiments, the thicknesses, and materials of the alternating layers of the first and second layered films 36 and 38 are configured so that the window 24 has, in addition to relatively high transmittance in the visible spectrum, a relatively low reflectance in the visible spectrum. For example, in embodiments, the thicknesses, and materials of the alternating layers of the first and second layered films 36 and 38 are configured so that the window 24 has an average reflectance of less than or equal to 30% (e.g., less than or equal to 20%, less than or equal to 10%), calculated from 400 nm to 700 nm, for light incident on the window 24 at angles of incidence of 15° or less. In embodiments, the thicknesses, and materials of the alternating layers of the first and second layered films 36 and 38 are configured so that the window 24 has an average reflectance of less than or equal to 20%, calculated from 400 nm to 700 nm, at angles of incidence of 60° or less.

As a result of the structures of the first and second layered films 36 and 38 described herein, the window may include a maximum nanoindentation hardness of greater than or equal to 10 and an average transmittance of greater than or equal to 90%, calculated over a 50 nm primary wavelength range of interest around a central that is greater than or equal to 1400 nm and less than or equal to 1600 nm, for light that is incident on the window 24 at angles of incidence of 15° or less. Additionally, the window 24 may exhibit S and P polarization transmittances of greater than or equal to 85% (e.g., greater than or equal to 90%, greater than or equal to 92%), calculated over the primary wavelength range of interest for light incident on the window 24 at angles of incidence of 60° or less. Additionally, the window 24 may also exhibit an average reflectance of less than or equal to 0.5%, calculated over the primary wavelength range of interest for light incident on the window 24 at angles of incidence of 15° or less. Additionally, the window 24 may also exhibit an average transmittance of greater than or equal to 80%, calculated over a secondary wavelength range of interest from 400 nm to 700 nm, for light that is incident on the window 24 at angles of incidence of 15° or less. Additionally, the window 24 may also exhibit an average reflectance of less than or equal to 10%, calculated over the secondary wavelength range of interest, for light that is incident on the window 24 at angles of incidence of 15° or less. Such a combination of damage resistance, and high optical performance over two distinct wavelength ranges of interest, separated from one another by more than 400 nm, facilitates providing durable sensor packages containing an array of sensor components.

In embodiments, each layer of the first and second layered films 36 and 38 may be formed on the substrate 30 by a vacuum deposition technique such as, for example, chemical vapor deposition (e.g., plasma enhanced chemical vapor deposition (PECVD), low-pressure chemical vapor deposition, atmospheric pressure chemical vapor deposition, and plasma-enhanced atmospheric pressure chemical vapor deposition), physical vapor deposition (e.g., reactive or nonreactive sputtering or laser ablation), thermal or e-beam evaporation and/or atomic layer deposition. Liquid-based methods may also be used such as spraying, dipping, spin coating, or slot coating (e.g., using sol-gel materials). Generally, vapor deposition techniques may include a variety of vacuum deposition methods which can be used to produce thin films. For example, physical vapor deposition uses a physical process (such as heating or sputtering) to produce a vapor of material, which is then deposited on the object which is coated. Preferred methods of fabricating the first and second layered films 36 and 38 include reactive sputtering, metal-mode reactive sputtering and PECVD processes.

### EXAMPLES

The following examples are all modeled examples using computer facilitated modeling to demonstrate how the quantity, thicknesses, number, and materials of the layers of the first layered film 36 and the second layered film 38 can be configured so that the window 24 has a desired average percentage transmittance and average percentage reflectance as a function of the wavelength and angle of incidence of the incident electromagnetic radiation.

The refractive indices of the materials in each of the materials and extinction coefficients were measured as a function of wavelength throughout the spectral range of 400 nm to 1600 nm. The refractive indices and optical absorbance for SiNₓ, SiO₂, and an aluminosilicate glass substrate (Coming code 2320) are provided in the Table A below. Those materials are utilized in the following examples as the higher refractive index materials 40, the lower refractive index materials 42, and the substrate 30.

TABLE A

| SiNₓ | | | SiO₂ | | |
|---|---|---|---|---|---|
| Wavelength (nm) | n | k | Wavelength (nm) | n | k |
| 250.24 | 2.39286 | 0.05616 | 250.77 | 1.52322 | 0 |
| 299.48 | 2.24497 | 0.01248 | 300.01 | 1.50437 | 0 |
| 350.31 | 2.16478 | 0.00309 | 349.25 | 1.49356 | 0 |
| 399.52 | 2.12156 | 0.00113 | 400.08 | 1.48656 | 0 |
| 450.3 | 2.09372 | 0.00047 | 449.31 | 1.482 | 0 |
| 499.45 | 2.07562 | 0.00023 | 500.09 | 1.47866 | 0 |
| 550.14 | 2.06238 | 0.00012 | 549.24 | 1.47627 | 0 |
| 600.76 | 2.05268 | 0.00007 | 599.93 | 1.47439 | 0 |
| 649.74 | 2.04553 | 0.00004 | 650.56 | 1.47291 | 0 |
| 700.22 | 2.03978 | 0.00003 | 699.53 | 1.47175 | 0 |
| 750.6 | 2.03523 | 0.00002 | 749.99 | 1.47076 | 0 |
| 849.48 | 2.02863 | 0.00001 | 850.61 | 1.46922 | 0 |
| 949.45 | 2.02401 | 0.00001 | 950.74 | 1.46804 | 0 |
| 1049.51 | 2.02068 | 0 | 1050.4 | 1.46708 | 0 |
| 1151.64 | 2.01816 | 0 | 1151.16 | 1.46625 | 0 |
| 1250.69 | 2.01629 | 0 | 1249.17 | 1.46552 | 0 |
| 1350.06 | 2.01482 | 0 | 1351.18 | 1.46481 | 0 |
| 1449.74 | 2.01365 | 0 | 1450.39 | 1.46414 | 0 |
| 1549.74 | 2.01269 | 0 | 1550.21 | 1.46349 | 0 |
| 1650.05 | 2.0119 | 0 | 1650.63 | 1.46283 | 0 |

TABLE A
Continued
Aluminosilicate glass (Corning Code 2320)

| Wavelength (nm) | n | k |
|---|---|---|
| 253.99 | 1.56564 | 0.00011 |
| 299.99 | 1.54076 | 0.00001 |
| 349.99 | 1.52695 | 0 |
| 399.99 | 1.51948 | 0 |
| 449.99 | 1.51361 | 0 |
| 499.99 | 1.51024 | 0 |
| 550 | 1.50798 | 0 |
| 600 | 1.5051 | 0 |
| 650 | 1.50388 | 0 |
| 700 | 1.50256 | 0 |
| 750 | 1.50092 | 0 |
| 798 | 1.50069 | 0 |
| 949.7 | 1.49633 | 0 |
| 1049.7 | 1.49525 | 0 |
| 1151.1 | 1.49434 | 0 |
| 1249.7 | 1.49357 | 0 |
| 1352.3 | 1.49284 | 0 |
| 1452.1 | 1.49218 | 0 |
| 1549.0 | 1.49156 | 0 |
| 1649.8 | 1.49095 | 0 |

These refractive indices were then used to calculate transmission and reflectance spectra. The modeled examples use a single refractive index value in their descriptive tables for convenience, which corresponds to a point selected from the refractive index dispersion curves at about 1550 nm wavelength.

Example 1—The window 24 of Example 1 included a first layered film 36 over a first surface 32 of a substrate 30 of an aluminosilicate glass (Corning code 2320). The window 24 also included a second layered film 38 over a second surface 34 of the substrate 30. The first layered film 36 included twenty-nine (29) alternating layers of SiO₂ as the lower refractive index material 42 and SiNₓ as the higher refractive index material 40. Layer 20 was the scratch resistant layer of the higher refractive index material 40, having a thickness of 2000 nm. Layers 1-19 were optical control layers having a combined thickness of 1406.9 nm separating the scratch resistant layer from the terminal surface 44. Layers 21-29 were index matching layers separating the scratch resistance layer from the first surface 32 and having a combined thickness of 319.1 nm. In this example, the scratch resistant layer constituted 53.68% of the thickness of the first layered film 36.

The second layered film 38 included seventeen (17) alternating layers of the lower refractive index material 42 and the higher refractive index material 40. In this example, the lower refractive index material 42 was SiO₂, while the higher refractive index material 40 was SiNₓ.

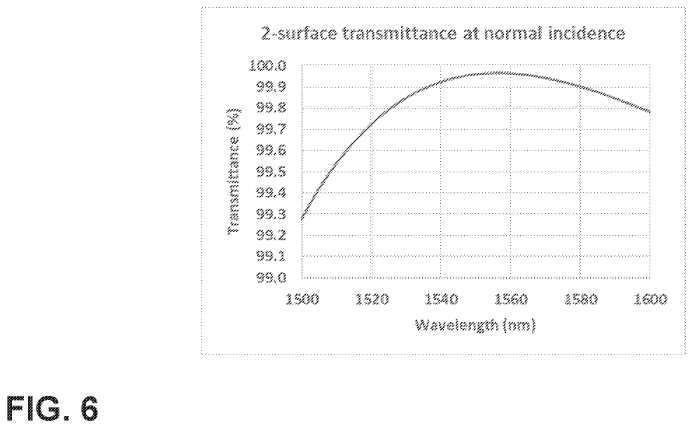

The thicknesses of the layers of the first layered film 36 and the second layered film 38 were configured as set forth in Table 1 below and used to calculate the transmittance, reflectance, and CIELAB color space values set forth in FIGS. 6-10.

TABLE 1
Example 1 Layer Design

| | | | Physical |
|---|---|---|---|
| | | Refractive Index | Thickness |
| Layer | Material | @1550 nm | (nm) |
| Medium | Air | 1 | |
| | Perfluoropolyether | ~1.4 | 4-8 |
| 1 | SiO₂ | 1.46349 | 278.7 |
| 2 | SiNₓ | 2.01269 | 143.9 |
| 3 | SiO₂ | 1.46349 | 28.2 |
| 4 | SiNₓ | 2.01269 | 55.8 |
| 5 | SiO₂ | 1.46349 | 8.4 |
| 6 | SiNₓ | 2.01269 | 88.3 |
| 7 | SiO₂ | 1.46349 | 181.7 |
| 8 | SiNₓ | 2.01269 | 42.5 |
| 9 | SiO₂ | 1.46349 | 8.3 |
| 10 | SiNₓ | 2.01269 | 78.7 |
| 11 | SiO₂ | 1.46349 | 79.8 |
| 12 | SiNₓ | 2.01269 | 8.3 |
| 13 | SiO₂ | 1.46349 | 74.0 |
| 14 | SiNₓ | 2.01269 | 137.4 |
| 15 | SiO₂ | 1.46349 | 60.9 |
| 16 | SiNₓ | 2.01269 | 17.6 |
| 17 | SiO₂ | 1.46349 | 63.7 |
| 18 | SiNₓ | 2.01269 | 36.5 |
| 19 | SiO₂ | 1.46349 | 19.3 |
| 20 | SiNₓ | 1.98699 | 2000.0 |
| 21 | SiO₂ | 1.46349 | 20.1 |
| 22 | SiNₓ | 2.01269 | 43.1 |
| 23 | SiO₂ | 1.46349 | 41.8 |
| 24 | SiNₓ | 2.01269 | 34.3 |
| 25 | SiO₂ | 1.46349 | 57.0 |
| 26 | SiNₓ | 2.01269 | 25.0 |
| 27 | SiO₂ | 1.46349 | 66.1 |
| 28 | SiNₓ | 2.01269 | 12.1 |
| 29 | SiO₂ | 1.46349 | 25.0 |
| Substrate | Aluminosilicate glass (2320) | 1.49156 | |
| 31 | SiO₂ | 1.46349 | 25.0 |
| 32 | SiNₓ | 2.01269 | 20.8 |
| 33 | SiO₂ | 1.46349 | 47.0 |
| 34 | SiNₓ | 2.01269 | 39.9 |
| 35 | SiO₂ | 1.46349 | 53.5 |
| 36 | SiNₓ | 2.01269 | 25.2 |
| 37 | SiO₂ | 1.46349 | 85.5 |
| 38 | SiNₓ | 2.01269 | 14.6 |
| 39 | SiO₂ | 1.46349 | 86.4 |
| 40 | SiNₓ | 2.01269 | 9.1 |
| 41 | SiO₂ | 1.46349 | 443.5 |
| 42 | SiNₓ | 2.01269 | 18.8 |
| 43 | SiO₂ | 1.46349 | 27.7 |
| 44 | SiNₓ | 2.01269 | 86.8 |
| 45 | SiO₂ | 1.46349 | 24.6 |
| 46 | SiNₓ | 2.01269 | 17.0 |
| 47 | SiO₂ | 1.46349 | 320.0 |
| Medium | Air | 1 | |

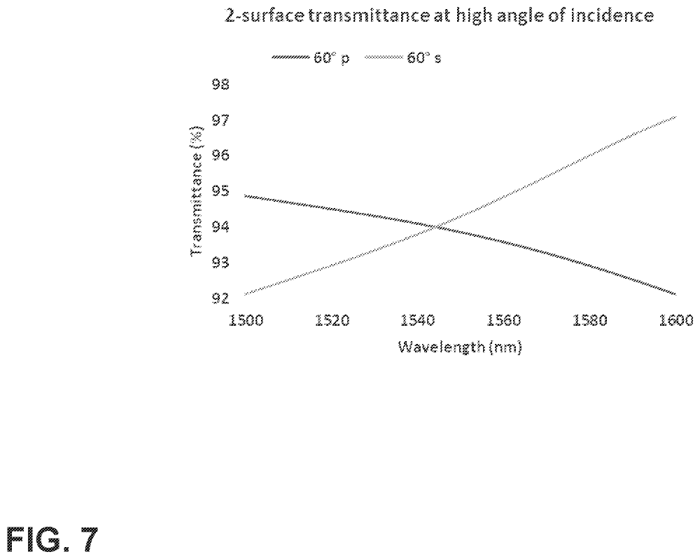

As revealed in FIG. 6, the quantity, thicknesses, and materials of the first layered film 36 and the second layered film 38 have been configured so that the window 24 of Example 1 has a percentage transmittance of above 99.3 percent for light normally incident on the first surface 32 or the second surface 34 throughout a wavelength range extending from 1500 nm to 1600 nm. As revealed in FIG. 7, the quantity, thicknesses, and materials of the first layered film 36 and the second layered film 38 have been configured so that the window 24 of Example 1 has an average P polarization transmittance and an average S polarization transmittance, calculated a wavelength range of interest from 1500 nm to 1600 nm, of greater than 92% for light incident on the first surface and the second surface at angles within 60° of normal to the first surface and the second surface. Indeed, the S and P polarization transmittances are greater than 92% throughout the wavelength range of interest from 1500 nm to 1600 nm.

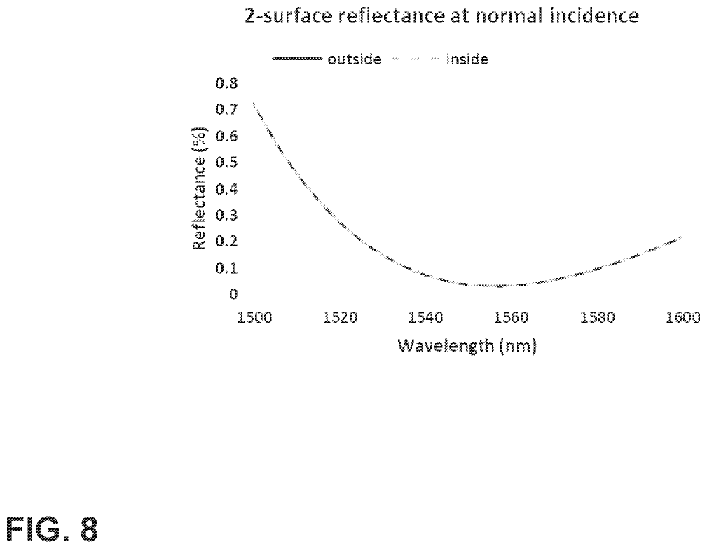

As revealed in FIG. 8, the quantity, thicknesses, and materials of the first layered film 36 and the second layered film 38 have been configured so that the window 24 of Example 1 has a percentage reflectance off of the terminal surface 44 of the first layered film 36 and the terminal surface 48 of the second layered film 38 of under 1 percent (under 0.7 percent) for light normally incident on the substrate 300 within the approximate wavelength range of 1500 nm to 1600 nm. The reflectance from the terminal surface 44 is comparable to that from the terminal surface 48, as the first and second layered films 36 and 38 were constructed of materials having relatively low absorbance in the referenced wavelength range. As shown, the modelled reflectance reaches a minimum value of approximately 0.05% at about 1550 nm, and the reflectance is less than 0.2% throughout the wavelength range of 1525 nm to 1575 nm.

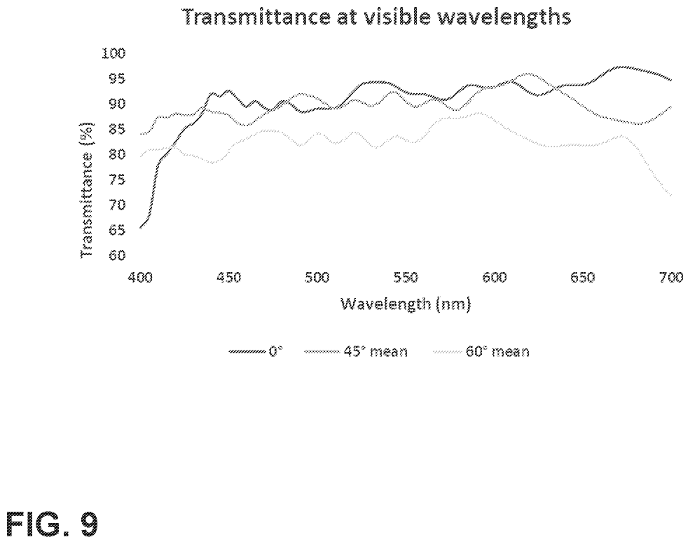

As revealed in FIG. 9, the quantity, thicknesses, and materials of the first layered film 36 and the second layered film 38 have been configured so that the window 24 of Example 1 has a transmittance greater than 66.67% throughout the visible spectrum for light normally incident on the terminal surface 44. The average transmittance, calculated throughout the visible spectrum, is greater than 85% for light normally incident on the terminal surface. For wavelengths less than about 420 nm, the transmittance was greater at 60° angles of incidence than the transmittance for normally incident light. For wavelengths less than about 440 nm, the transmittance was greater at 45° angles of incidence than the transmittance for normally incident light. Such results indicate that the window 24 according to Example 1 may be well suited for sensor in the visible range that is not orientated parallel to the surfaces 32 and 34, in the event that maximum transmission at wavelengths beneath 450 nm is desired.

As shown in FIG. 9, the quantity, thicknesses, and materials of the first layered film 36 and the second layered film 38 have been configured so that the window 24 of Example 1 has a transmittance, throughout a wavelength range extending from 450 nm to 700 nm, of greater than or equal to 85% for light incident on the first layered film at angles of incidence of 45° or less. The quantity, thicknesses, and materials of the first layered film 36 and the second layered film 38 have also been configured so that the window 24 of Example 1 has, throughout a wavelength range extending from 475 nm to 675 nm, a transmittance that is greater than or equal to 80% for light incident on the first layered film at angles of incidence of 60° or less. The average transmittance, calculated throughout the visible spectrum, was greater than 80% at 0°, 45°, and 60° angles of incidence. Such results indicate the ability of the window 24 according to Example 1 to provide relatively high transmission within two distinct wavelength ranges of interest, facilitating multi-sensor operation.

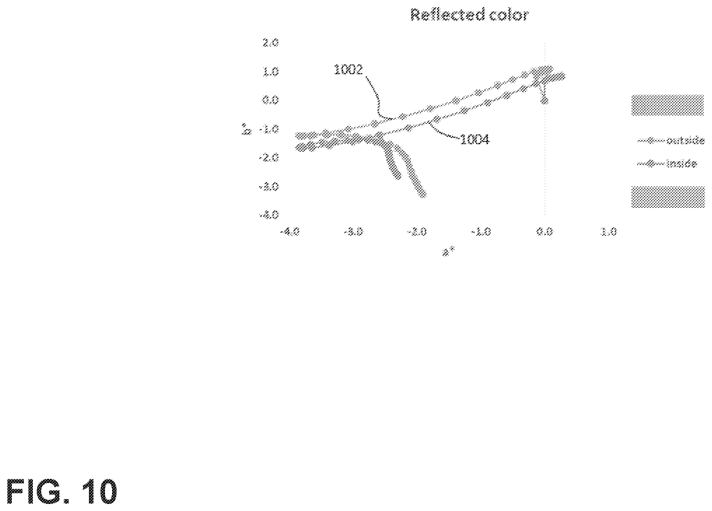

As reveled in FIG. 10, the quantity, thicknesses, and materials of the first layered film 36 and the second layered film 38 have been configured so that the window 24 of Example 1 has a neutral appearance when viewed from the terminal surface 44 of the first layered film. FIG. 10 provides simulated CIELAB single-surface reflected color data for Example 1 for light reflected off of the terminal surface 44. A curve 1004 provides the values when the window 24 is viewed from the first layered film 36. A curve 1002 provides the values when the window 24 is viewed from the second layered film 38. The color of the single-surface reflected light can be characterized using CIELAB color coordinates. The a* axis in color space is representative of the green-red color component, with negative a* values corresponding to green and positive a* values corresponding to red. The b* axis in color space is representative of the blue-yellow component, with negative b* values corresponding to blue and positive b* values corresponding to yellow. The closer the a* and b* values are to the origin, the more neutral in color the reflected light will appear to an observer. The CIELAB a* and b* values were generated by simulating an illuminant source at a plurality of different angles of incidence, ranging from 0° to 90°. As shown, the a* values ranges from about −3.5 to about 0.4, while the b* values ranges from about −3.5 to about 1.1, regardless of whether the window 24 was viewed from the terminal surface 44 or the terminal surface 48. This indicates that the window 24 according to example 1 has a neutral appearance when viewed form the external environment 26 (see FIG. 1).

Nanoindentation hardness values were also modeled as a function of displacement into the first layered film 36 according to Example 1. At an indentation depth of 250 nm, the simulated hardness value was 10.1 GPa. At an indentation depth of 1000 nm, the simulated hardness was 12.0 GPa. Such results indicate that the window 24 according to Example 1 provides the damage resistance and optical performance attributes to facilitate multi-sensor operation, as described herein.

Example 2—The window 24 of Example 2 included a first layered film 36 over a first surface 32 of a substrate 30 of an aluminosilicate glass (Corning code 2320). Example 2 may represent an embodiment where one of the layered films described herein (i.e., the first layered film 36) is disposed on a surface of a cover glass for a mobile device. In Example 2, the first layered film 36 included twenty-nine (29) alternating layers of SiO₂ as the lower refractive index material 42 and SiNₓ as the higher refractive index material 40. Layer 20 was the scratch resistant layer of the higher refractive index material 40, having a thickness of 2000 nm. Layers 1-19 were optical control layers having a combined thickness of 1372.8 nm separating the scratch resistant layer from the terminal surface 44 (representing an outermost surface of an outer SiO₂ layer in this example). Layers 21-29 were index matching layers separating the scratch resistance layer from the first surface 32 and having a combined thickness of 354.4 nm. In this example, the scratch resistant layer constituted 53.66% of the thickness of the first layered film 36.

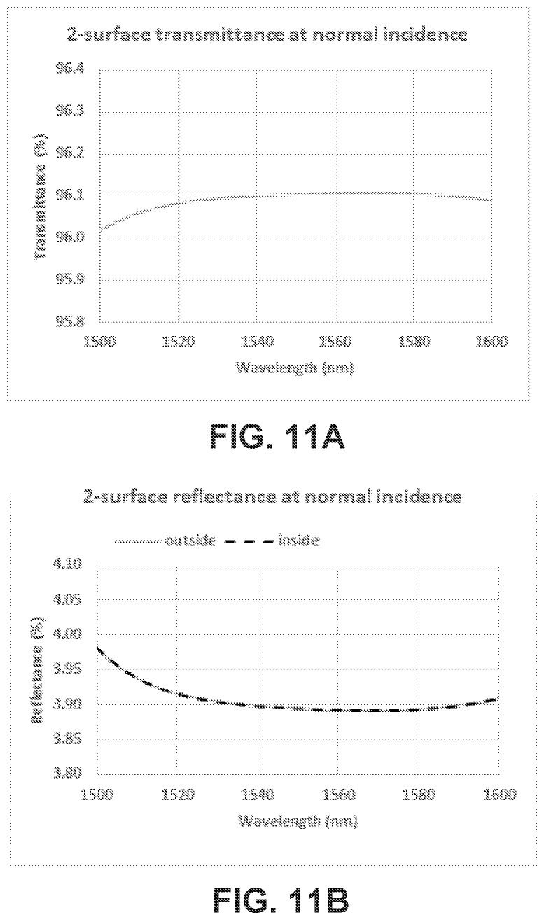

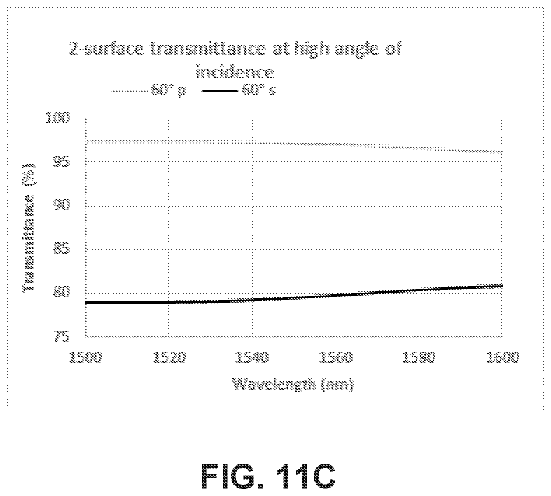

The thicknesses of the layers of the first layered film 36 were configured as set forth in Table 2 below and used to calculate the transmittance, reflectance, and CIELAB color space values set forth in FIGS. 11A-13B.

TABLE 2
Example 2 Layer Design

| | | | Physical |
|---|---|---|---|
| | | Refractive Index | Thickness |
| Layer | Material | @1550 nm | (nm) |
| Medium | Air | 1 | |
| | Perfluoropolyether | ~1.4 | 4-8 |
| 1 | SiO2 | 1.46349 | 273.4 |
| 2 | SiNx | 2.01269 | 143.9 |
| 3 | SiO2 | 1.46349 | 34.0 |
| 4 | SiNx | 2.01269 | 40.2 |
| 5 | SiO2 | 1.46349 | 18.7 |
| 6 | SiNx | 2.01269 | 86.7 |
| 7 | SiO2 | 1.46349 | 174.9 |
| 8 | SiNx | 2.01269 | 41.3 |
| 9 | SiO2 | 1.46349 | 10.2 |
| 10 | SiNx | 2.01269 | 78.7 |
| 11 | SiO2 | 1.46349 | 97.4 |
| 12 | SiNx | 2.01269 | 9.4 |
| 13 | SiO2 | 1.46349 | 54.1 |
| 14 | SiNx | 2.01269 | 134.2 |
| 15 | SiO2 | 1.46349 | 50.2 |
| 16 | SiNx | 2.01269 | 21.4 |
| 17 | SiO2 | 1.46349 | 44.7 |
| 18 | SiNx | 2.01269 | 37.9 |
| 19 | SiO2 | 1.46349 | 21.6 |
| 20 | SiNx | 1.98699 | 2000.0 |
| 21 | SiO2 | 1.46349 | 20.8 |
| 22 | SiNx | 2.01269 | 45.5 |
| 23 | SiO2 | 1.46349 | 40.2 |
| 24 | SiNx | 2.01269 | 39.2 |
| 25 | SiO2 | 1.46349 | 61.6 |
| 26 | SiNx | 2.01269 | 21.8 |
| 27 | SiO2 | 1.46349 | 85.6 |
| 28 | SiNx | 2.01269 | 14.7 |
| 29 | SiO2 | 1.46349 | 25.0 |
| Substrate | Aluminosilicate glass (2320) | 1.49156 | |
| Medium | Air | 1 | |

As revealed in FIG. 11A, the quantity, thicknesses, and materials of the first layered film 36 have been configured so that the window 24 of Example 2 has a percentage transmittance of above 96 percent for light normally incident on the first surface 32 or the second surface 34 throughout a wavelength range extending from 1500 nm to 1600 nm.

As revealed in FIG. 11B, the quantity, thicknesses, and materials of the first layered film 36 have been configured so that the window 24 of Example 2 has an average reflectance off of the terminal surface 44 of the first layered film 36 of under 4 percent for light normally incident on the substrate 300 within the approximate wavelength range of 1500 nm to 1600 nm. The reflectance from the surface 34 (not covered by a layered film in this example) is comparable to that from the terminal surface 44, as the first layered film 36 constructed of materials having relatively low absorbance in the referenced wavelength range. As shown, the modelled reflectance reaches a minimum value of approximately 3.89% at about 1570 nm, and the reflectance is less than 3.9% throughout the wavelength range of 1530 nm to about 1595 nm.

As revealed in FIG. 11C, the quantity, thicknesses, and materials of the first layered film 36 have been configured so that the window 24 of Example 2 has an average P polarization transmittance and an average S polarization transmittance, calculated a wavelength range of interest from 1500 nm to 1600 nm, of greater than 78% for light incident on the first layered film 36 at angles within 60° of normal to the substrate 30. As shown, the P polarization transmittance is greater than 95% throughout the approximate spectral range of 1500 nm to 1600 nm, while the S polarization transmittance is greater than 78%.

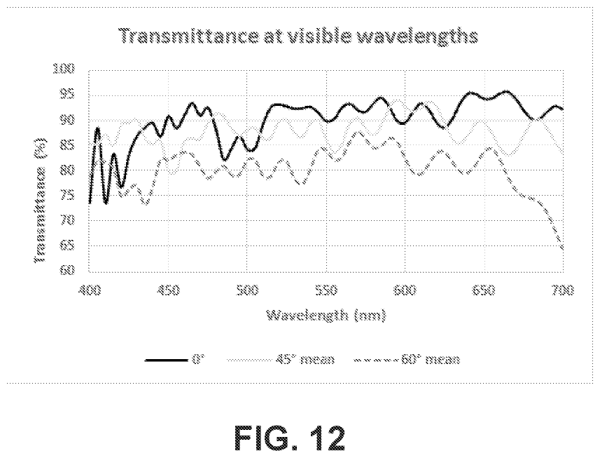

As revealed in FIG. 12, the quantity, thicknesses, and materials of the first layered film 36 have been configured so that the window 24 of Example 2 has a transmittance greater than 75% throughout the visible spectrum for light incident on the terminal surface 44 at angles of incidence of less than or equal to 45°. For light incident on the terminal surface 44 at angles of incidence of 45°, the window 24 of Example 2 has a transmittance that is greater than 79% throughout the visible spectrum. For light normally incident on the terminal surface 44, the window 24 of Example 2 has a transmittance that is greater than 73.5% throughout the visible spectrum. For light incident on the terminal surface 44 at angles of incidence of 60°, the window 24 of Example 2 has a transmittance that is greater than 64% throughout the visible spectrum. The transmittance values used to generate FIG. 12 are mean values (for polarizations).

Given that the materials of the window 24 of Example 2 have relatively low absorbance in the visible spectrum. It is believed that the reflectance values of the window 24 of Example 2 in the visible spectrum correspond to 100% less the transmittance values depicted in FIG. 12. As such, it is believed that the quantity, thicknesses, and materials of the first layered film 36 have been configured so that the window 24 of Example 2 has a reflectance of less than 25% throughout the visible spectrum for light incident on the terminal surface 44 at angles of incidence of less than or equal to 45°.

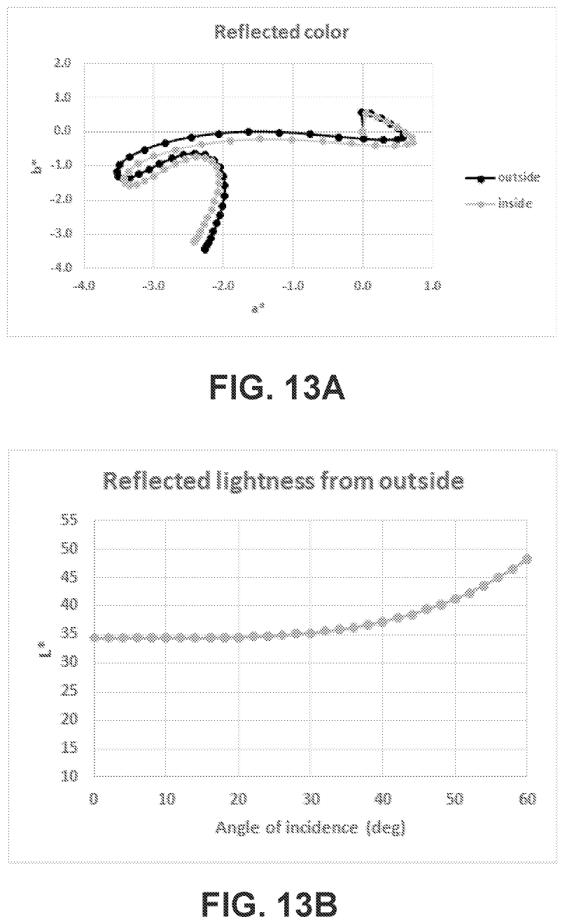

As reveled in FIG. 13A, the quantity, thicknesses, and materials of the first layered film 36 have been configured so that the window 24 of Example 2 has a neutral appearance when viewed from the terminal surface 44 of the first layered film 36 and when viewed from the surface 34 of the substrate 30 opposite the first layered film 36. As shown, the a* values range from about −3.5 to about 0.7, while the b* values range from about −3.5 to about 0.7, regardless of whether the window 24 was viewed from the terminal surface 44 or surface 34. This indicates that the window 24 according to Example 2 has a neutral appearance when viewed form the external environment 26 (see FIG. 1).

As revealed in FIG. 13B, the quantity, thicknesses, and materials of the first layered film 36 have been configured so that the window 24 of Example 2 exhibits a CIELAB L* value that is less than 50 for when the terminal surface 44 is viewed at angles of incidence of 60° or less. When viewed at angles of incidence of 35° or less, the window 24 of Example 2 exhibits a CIELAB L* value that is less than 35. Such results indicate that the window 24 of Example 2 exhibits a relatively opaque or dark appearance, rendering the first layered film 36 relatively inconspicuous to various viewers.

Embodiments of the present disclosure may be further understood in view of the following aspects.

A first aspect of the present disclosure includes a window for a sensing system including a substrate comprising a first surface and a second surface, the first surface and the second surface being primary surfaces of the substrate; a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film; a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film; and a maximum hardness, measured at the first layered film and by the Berkovich Indenter Hardness Test, of at least 10 GPa. The quantity, the thicknesses, and materials of the alternating layers of the first and second layered films are configured so that the window has; an average percentage transmittance, calculated over a 50 nm wavelength range of interest surrounding a central wavelength between 1400 nm and 1600 nm, of greater than 90% for light incident on the first surface and the second surface at angles of incidence of less than or equal to 15°; an average reflectance, calculated over the 50 nm wavelength range of interest, of less than 0.5% for light incident on the first surface and the second surface at angles of less than or equal to 15°; and an average percentage transmission, calculated from 400 nm to 700 nm, of greater than 80% for light incident on the first surface and the second surface at angles of incidence of less than or equal to 15°.

A second aspect of the present disclosure includes a window according to the first aspect, wherein the quantity, the thicknesses, and materials of the alternating layers of the first and second layered films are configured so that the window has an average P polarization transmittance and an average S polarization transmittance, calculated over the 50 nm wavelength range of interest, of greater than 85% for light incident on the first surface and the second surface at angles of incidence of less than or equal to 60°.

A third aspect of the present disclosure includes a window according to any of the first through the second aspects, wherein the quantity, the thicknesses, and materials of the alternating layers of the first and second layered films are configured so that the window has an average transmittance of greater than 85%, calculated from 400 nm to 700 nm, for light normally incident in the first layered film.

A fourth aspect of the present disclosure includes a window according to any of the first through the third aspects, wherein the quantity, the thicknesses, and materials of the alternating layers of the first and second layered films are configured so that the window has a CIELAB L* value of less than or equal to 50 for angles of incidence of less than or equal to 60° on the first layered film.

A fifth aspect of the present disclosure includes a window according to any of the first through the fourth aspects, wherein the quantity, the thicknesses, and materials of the alternating layers of the first and second layered films are configured so that the window has CIELAB a and b* values of greater than or equal to −6.0 and less than or equal to 6.0 when viewed from a side of the first layered film.

A sixth aspect of the present disclosure includes a window according to any of the first through the fifth aspects, wherein the quantity, the thicknesses, and materials of the alternating layers of the first and second layered films are configured so that the window has an average reflectance, calculated throughout the visible spectrum, for light incident on the first layered film, of less than or equal to 30%, at angles of incidence of 60° or less.

A seventh aspect of the present disclosure includes a window according to any of the first through the sixth aspects, wherein the quantity, the thicknesses, and materials of the alternating layers of the first and second layered films are configured so that the window has an average percentage transmittance, calculated over the 50 nm wavelength range of interest, of greater than 99.5% for light normally incident on the first surface and the second surface.

An eighth aspect of the present disclosure includes a window according to any of the first through the seventh aspects, wherein the substrate is a glass substrate.

A ninth aspect of the present disclosure includes a window according to any of the first through the eighth aspects, wherein the substrate has a region contiguous with the first surface that is under compressive stress, and the absolute value of a maximum of the compressive stress is at least 600 MPa.

A tenth aspect of the present disclosure includes a window according to any of the first through the ninth aspects, wherein the substrate has a thickness of between about 100um and about 5 mm.

An eleventh aspect of the present disclosure includes a window according to any of the first through the tenth aspects, wherein the refractive index of the substrate for electromagnetic radiation having a wavelength of 1550nm is from about 1.45 to about 1.55.

A twelfth aspect of the present disclosure includes a window according to any of the first through the eleventh aspects, wherein the refractive index of the one or more higher refractive index materials is from about 1.7 to about 4.0, and wherein the refractive index of the one or more lower refractive index materials is from about 1.3 to about 1.6.

A thirteenth aspect of the present disclosure includes a window according to any of the first through the twelfth aspects, wherein a difference in the refractive index of any of the one or more higher refractive index materials and any of the one or more lower refractive index materials is about 0.5 or greater.

A fourteenth aspect of the present disclosure includes a window according to any of the first through the thirteenth aspects, wherein one of the alternating layers of the first layered film that is farthest from the substrate forms a terminal surface material of the window, the terminal surface material of the window comprising the lower refractive index material.

A fifteenth aspect of the present disclosure includes a window according to any of the first through the fourteenth aspects, wherein first layered firm comprises a scratch resistant layer formed of one of the one or more higher refractive index materials and having a thickness of greater than or equal to 500 nm.

A sixteenth aspect of the present disclosure includes a window according to any of the first through the fifteenth aspects, wherein the thickness of the scratch resistant layer is greater than or equal to 1500 nm and less than or equal to 5000 nm.

A seventeenth aspect of the present disclosure includes a window according to any of the first through the sixteenth aspects, wherein the scratch resistant layer is separated from the terminal surface by a plurality of the alternating layers of the one or more lower index materials and the one or more higher index materials of the first layered film.

An eighteenth aspect of the present disclosure includes a window according to any of the first through the seventeenth aspects, wherein the scratch resistant layer is separated from the terminal surface by at least 1000 nm.

A nineteenth aspect of the present disclosure includes a window according to any of the first through the eighteenth aspects, wherein the maximum hardness, measured at the layered film and by the Berkovich Indenter Hardness Test, is at least 12 GPa.

A twentieth aspect of the present disclosure includes a window according to any of the first through the nineteenth aspects, wherein a hardness, measured at the first layered film and by the Berkovich Indenter Hardness Test, is at least 8 GPa over a depth range of 300 nm to 2000 nm.

A twenty first aspect of the present disclosure includes a window according to any of the first through the twentieth aspects, wherein a hardness, measured at the first layered film and by the Berkovich Indenter Hardness Test, is at least 9 GPa over a depth range of 800 nm to 2000 nm.

A twenty second aspect of the present disclosure includes a window according to any of the first through the twenty first aspects, further comprising an easy-to-clean coating dispose don the first layered film.

A twenty third aspect of the present disclosure includes a window according to any of the first through the twenty second aspects, wherein, throughout a wavelength range extending from 400 nm to 700 nm, a percentage transmission of the window is greater than or equal to 80% for light incident on the first layered film at angles of incidence of 45° or less.

A twenty fourth aspect of the present disclosure includes a window according to any of the first through the twenty third aspects, wherein, throughout a wavelength range extending from 400 nm to 700 nm, a percentage transmission of the window is greater than or equal to 75% for light incident on the first layered film at angles of incidence of 60° or less.

A twenty fifth aspect of the present disclosure includes a window for a sensing system that includes a substrate comprising a first surface and a second surface, the first surface and the second surface being primary surfaces of the substrate; a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film; a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film; and a maximum hardness, measured at the first layered film and by the Berkovich Indenter Hardness Test, of at least 10 GPa. The quantity, the thicknesses, and materials of the alternating layers of the first and second layered films are configured so that the window has; an average reflectance, calculated over a 50 nm wavelength range of interest surrounding a central wavelength between 1400 nm and 1600 nm, of less than 0.5% for light incident on the first surface and the second surface at angles of less than or equal to 15°; CIELAB a* and b* values of greater than or equal to −6.0 and less than or equal to 6.0 when viewed from a side of the first layered film; and an average percentage transmission, calculated from 400 nm to 700 nm, of greater than 70% for light incident on the first surface and the second surface at angles of incidence of less than or equal to 15°.

A twenty sixth aspect of the present disclosure includes a window according to the twenty fifth aspect, wherein, throughout a wavelength range extending from 400 nm to 700 nm, a percentage transmission of the window is greater than or equal to 80% for light incident on the first layered film at angles of incidence of 45° or less.

A twenty seventh aspect of the present disclosure includes a window according to any of the twenty fifth through the twenty sixth aspects, wherein, throughout a wavelength range extending from 400 nm to 700 nm, a percentage transmission of the window is greater than or equal to 75% for light incident on the first layered film at angles of incidence of 60° or less.

A twenty eighth aspect of the present disclosure includes a window according to any of the twenty fifth through the twenty seventh aspects, wherein the quantity, the thicknesses, and materials of the alternating layers of the first and second layered films are configured so that the window has an average percentage transmittance, calculated over the 50 nm wavelength range of interest, of greater than 90% for light incident on the first surface and the second surface at angles of incidence of less than or equal to 15°.

A twenty ninth aspect of the present disclosure includes a window according to any of the twenty fifth through the twenty eighth aspects, wherein the quantity, the thicknesses, and materials of the alternating layers of the first and second layered films are configured so that the window has an average reflectance, calculated throughout the visible spectrum, for light normally incident on the first layered film, of less than or equal to 30%.

A thirtieth aspect of the present disclosure includes a window according to any of the twenty fifth through the twenty ninth aspects, wherein the quantity, the thicknesses, and materials of the alternating layers of the first and second layered films are configured so that the window has an average P polarization transmittance and an average S polarization transmittance, calculated over a 50 nm wavelength range of interest between 1400 nm and 1600 nm, of greater than 85% for light incident on the first surface and the second surface at angles of incidence of less than or equal to 60°.

A thirty first aspect of the present disclosure includes a window according to any of the twenty fifth through the thirtieth aspects, wherein the average P polarization transmittance and the average S polarization transmittance, calculated over the 50 nm wavelength range of interest between 1400 nm and 1600 nm, are greater than 92% for light incident on the first surface and the second surface at angles of incidence of less than or equal to 60°.

A thirty second aspect of the present disclosure includes a window according to any of the twenty fifth through the thirty first aspects, wherein the quantity, the thicknesses, and materials of the alternating layers of the first and second layered films are configured so that the window has an average percentage transmittance, calculated over the 50 nm wavelength range of interest, of greater than 99.5% for light normally incident on the first surface and the second surface.

A thirty third aspect of the present disclosure includes a window according to any of the twenty fifth through the thirty second aspects, wherein the maximum hardness, measured at the layered film and by the Berkovich Indenter Hardness Test, is at least 12 GPa.

A thirty fourth aspect of the present disclosure includes a window according to any of the twenty fifth through the thirty third aspects, wherein a hardness, measured at the first layered film and by the Berkovich Indenter Hardness Test, is at least 8 GPa over a depth range of 300 nm to 2000 nm.

A thirty fifth aspect of the present disclosure includes a window according to any of the twenty fifth through the thirty fourth aspects, wherein: one of the alternating layers of the first layered film that is farthest from the substrate forms a terminal surface material of the window, the terminal surface material of the window comprising the lower refractive index material, the first layered firm comprises a scratch resistant layer formed of one of the one or more higher refractive index materials and having a thickness that is greater than or equal to 1500 nm and less than or equal to 5000 nm, and the scratch resistant layer is separated from the terminal surface by at least 1000 nm.

A thirty sixth aspect of the present disclosure includes a window according to any of the twenty fifth through the thirty fifth aspects, wherein a layer of the alternating layers of the second layered film most proximate to the substrate is a layer of the lower refractive index material and comprises a thickness of less than or equal to 50 nm.

A thirty seventh aspect of the present disclosure includes a window for a sensing system includes a substrate comprising a first surface and a second surface, the first surface and the second surface being primary surfaces of the substrate; a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film; a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film; and a maximum hardness, measured at the first layered film and by the Berkovich Indenter Hardness Test, of at least 10 GPa, The quantity, the thicknesses, and materials of the alternating layers of the first and second layered films are configured so that the window has: an average reflectance, calculated over a 50 nm wavelength range of interest between 1400 nm and 1600 nm, of less than 0.5% for light incident on the first surface and the second surface at angles of less than or equal to 15°; an average percentage transmission, calculated from 400 nm to 700 nm, of greater than 70% for light incident on the first surface and the second surface at angles of incidence of less than or equal to 15°; and an average reflectance, calculated from 400 nm to 700 nm, for light normally incident on the first layered film, of less than or equal to 30%.

A thirty eighth aspect of the present disclosure includes a window according to the thirty seventh aspect, wherein the quantity, the thicknesses, and materials of the alternating layers of the first and second layered films are configured so that the window has an average P polarization transmittance and an average S polarization transmittance, calculated over the 50 nm wavelength range of interest, of greater than 85% for light incident on the first surface and the second surface at angles of incidence of less than or equal to 60°.

A thirty ninth aspect of the present disclosure includes a window according to any of the thirty seventh through the thirty eighth aspects, wherein the average P polarization transmittance and the average S polarization transmittance, calculated over the 50 nm wavelength range of interest, are greater than 92% for light incident on the first surface and the second surface at angles of incidence of less than or equal to 60°.

A fortieth aspect of the present disclosure includes a window according to any of the thirty seventh through the thirty ninth aspects, wherein the quantity, the thicknesses, and materials of the alternating layers of the first and second layered films are configured so that the window has a CIELAB L* value of less than or equal to 50 for angles of incidence of less than or equal to 60° on the first layered film.

A forty first aspect of the present disclosure includes a window according to any of the thirty seventh through the fortieth aspects, wherein the quantity, the thicknesses, and materials of the alternating layers of the first and second layered films are configured so that the window has CIELAB a* and b* values of greater than or equal to −6.0 and less than or equal to 6.0 when viewed from a side of the first layered film.

A forty second aspect of the present disclosure includes a window according to any of the thirty seventh through the forty first aspects, wherein the quantity, the thicknesses, and materials of the alternating layers of the first and second layered films are configured so that the window has an average percentage transmittance, calculated over a 50 nm wavelength range of interest between 1400 nm and 1600 nm, of greater than 99.5% for light normally incident on the first surface and the second surface.

A forty third aspect of the present disclosure includes a window according to any of the thirty seventh through the forty second aspects, wherein one of the alternating layers of the first layered film that is farthest from the substrate forms a terminal surface material of the window, the terminal surface material of the window comprising the lower refractive index material.

A forty fourth aspect of the present disclosure includes a window according to any of the thirty seventh through the thirty ninth aspects, wherein first layered firm comprises a scratch resistant layer formed of one of the one or more higher refractive index materials and having a thickness of greater than or equal to 500 nm.

A forty fifth aspect of the present disclosure includes a window according to any of the thirty seventh through the forty fourth aspects, wherein the thickness of the scratch resistant layer is greater than or equal to 1500 nm and less than or equal to 5000 nm.

A forty sixth aspect of the present disclosure includes a window according to any of the thirty seventh through the forty fifth aspects, wherein the scratch resistant layer is separated from the terminal surface by a plurality of the alternating layers of the one or more lower index materials and the one or more higher index materials of the first layered film.

A forty seventh aspect of the present disclosure includes a window according to any of the thirty seventh through the forty sixth aspects, wherein the scratch resistant layer is separated from the terminal surface by at least 1000 nm.

A forty eighth aspect of the present disclosure includes an article comprising: a substrate comprising a first surface and a second surface, the first surface and the second surface being primary surfaces of the substrate; a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film; a maximum hardness, measured at the first layered film and by the Berkovich Indenter Hardness Test, of at least 10 GPa, wherein the quantity, the thicknesses, and materials of the alternating layers of the first layered film are configured so that the window has: an average percentage transmittance, calculated over a 50 nm wavelength range of interest surrounding a central wavelength between 1200 nm and 1600 nm, of greater than 85% for light incident on the first layered film at angles of incidence of less than or equal to 15°; an average reflectance, calculated over the 50 nm wavelength range of interest, of less than 4.5% for light incident on the first layered film at angles of less than or equal to 15°; and an average percentage transmission, calculated from 400 nm to 700 nm, of greater than 75% for light incident on the first surface and the second surface at angles of incidence of less than or equal to 15°.

A forty ninth aspect of the present disclosure includes an article according to the forty eighth aspect, further comprising a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film.

A fiftieth aspect of the present disclosure includes an article according to any of the forty eighth to the forty ninth aspects, wherein the quantity, the thicknesses, and materials of the alternating layers of the first layered film are configured so that the window has a CIELAB L* value of less than or equal to 55 for angles of incidence of less than or equal to 60° on the first layered film.

A fifty first aspect of the present disclosure includes an article according to any of the forty eighth to the fiftieth aspects, wherein the quantity, the thicknesses, and materials of the alternating layers of the first layered film are configured so that the window has CIELAB a* and b* values of greater than or equal to −6.0 and less than or equal to 6.0 when viewed from a side of the first layered film.

A fifty second aspect of the present disclosure includes an article according to any of the forty eighth to the fifty first aspects, wherein first layered film comprises a scratch resistant layer formed of one of the one or more higher refractive index materials and having a thickness of greater than or equal to 500 nm.

A fifty third aspect of the present disclosure includes an article according to any of the forty eighth to the fifty second aspects, wherein the scratch resistant layer is separated from a terminal surface of the article by a plurality of the alternating layers of the one or more lower index materials and the one or more higher index materials of the first layered film.

A fifty fourth aspect of the present disclosure includes an article according to any of the forty eighth to the fifty third aspects, wherein the scratch resistant layer is separated from the terminal surface by at least 1000 nm.

It will be apparent to those skilled in the art that various modifications and variations can be made without departing from the spirit or scope of the claims.

1. A window for a sensing system comprising:
a substrate comprising a first surface and a second surface, the first surface and the second surface being primary surfaces of the substrate;
a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film;
a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film; and
a maximum hardness, measured at the first layered film and by the Berkovich Indenter Hardness Test, of at least 10 GPa,
wherein the quantity, the thicknesses, and materials of the alternating layers of the first and second layered films are configured so that the window has;
an average percentage transmittance, calculated over a 50 nm wavelength range of interest surrounding a central wavelength between 1400 nm and 1600 nm, of greater than 90% for light incident on the first surface and the second surface at angles of incidence of less than or equal to 15°;
an average reflectance, calculated over the 50 nm wavelength range of interest, of less than 0.5% for light incident on the first surface and the second surface at angles of less than or equal to 15°; and
an average percentage transmission, calculated from 400 nm to 700 nm, of greater than 80% for light incident on the first surface and the second surface at angles of incidence of less than or equal to 15°.

2. The window of claim 1, wherein the quantity, the thicknesses, and materials of the alternating layers of the first and second layered films are configured so that the window has an average P polarization transmittance and an average S polarization transmittance, calculated over the 50 nm wavelength range of interest, of greater than 85% for light incident on the first surface and the second surface at angles of incidence of less than or equal to 60°.

3. (canceled)

4. The window of claim 1, wherein the quantity, the thicknesses, and materials of the alternating layers of the first and second layered films are configured so that the window has a CIELAB L* value of less than or equal to 50 for angles of incidence of less than or equal to 60° on the first layered film, wherein the quantity, the thicknesses, and materials of the alternating layers of the first and second layered films are configured so that the window has CIELAB at and b* values of greater than or equal to −6.0 and less than or equal to 6.0 when viewed from a side of the first layered film.

5. (canceled)

6. The window of claim 1, wherein the quantity, the thicknesses, and materials of the alternating layers of the first and second layered films are configured so that the window has an average reflectance, calculated throughout the visible spectrum, for light incident on the first layered film, of less than or equal to 30%, at angles of incidence of 60° or less.

7. The window of claim 1, wherein the quantity, the thicknesses, and materials of the alternating layers of the first and second layered films are configured so that the window has an average percentage transmittance, calculated over the 50 nm wavelength range of interest, of greater than 99.5% for light normally incident on the first surface and the second surface.

8. The window of claim 1, wherein the substrate is a glass substrate.

9. (canceled)

10. (canceled)

11. (canceled)

12. The window of claim 1, wherein the refractive index of the one or more higher refractive index materials is from about 1.7 to about 4.0, and wherein the refractive index of the one or more lower refractive index materials is from about 1.3 to about 1.6, wherein a difference in the refractive index of any of the one or more higher refractive index materials and any of the one or more lower refractive index materials is about 0.5 or greater.

13. (canceled)

14. The window of claim 1, wherein one of the alternating layers of the first layered film that is farthest from the substrate forms a terminal surface material of the window, the terminal surface material of the window comprising the lower refractive index material.

15. The window of claim 14, wherein first layered firm comprises a scratch resistant layer formed of one of the one or more higher refractive index materials and having a thickness of greater than or equal to 500 nm.

16. (canceled)

17. The window of claim 15, wherein the scratch resistant layer is separated from the terminal surface by a plurality of the alternating layers of the one or more lower index materials and the one or more higher index materials of the first layered film.

18. The window of claim 17, wherein the scratch resistant layer is separated from the terminal surface by at least 1000 nm.

19. The window of claim 1, wherein the maximum hardness, measured at the layered film and by the Berkovich Indenter Hardness Test, is at least 12 GPa.

20. (canceled)

21. (canceled)

22. (canceled)

23. (canceled)

24. The window of claim 1, wherein, throughout a wavelength range extending from 400 nm to 700 nm, a percentage transmission of the window is greater than or equal to 75% for light incident on the first layered film at angles of incidence of 60° or less.

25. A window for a sensing system comprising:
a substrate comprising a first surface and a second surface, the first surface and the second surface being primary surfaces of the substrate;
a first layered film disposed on the first surface of the substrate, the first layered film comprising alternating layers of one or more higher refractive index materials and one or more lower refractive index materials, wherein refractive indices of the one or more higher refractive index materials of the first layered film are higher than refractive indices of the one or more lower refractive index materials of the first layered film;
a second layered film disposed on the second surface of the substrate, the second layered film comprising alternating layers of one or more higher refractive index materials and one or more lower refractive index materials, wherein refractive indices of the one or more higher refractive index materials of the second layered film are higher than refractive indices of the one or more lower refractive index materials of the second layered film; and
a maximum hardness, measured at the first layered film and by the Berkovich Indenter Hardness Test, of at least 10 GPa,
wherein the quantity, the thicknesses, and materials of the alternating layers of the first and second layered films are configured so that the window has:
an average reflectance, calculated over a 50 nm wavelength range of interest surrounding a central wavelength between 1400 nm and 1600 nm, of less than 0.5% for light incident on the first surface and the second surface at angles of less than or equal to 15°;
CIELAB a* and b* values of greater than or equal to −6.0 and less than or equal to 6.0 when viewed from a side of the first layered film; and
an average percentage transmission, calculated from 400 nm to 700 nm, of greater than 70% for light incident on the first surface and the second surface at angles of incidence of less than or equal to 15°.

26. (canceled)

27. The window of claim 25, wherein, throughout a wavelength range extending from 400 nm to 700 nm, a percentage transmission of the window is greater than or equal to 75% for light incident on the first layered film at angles of incidence of 60° or less.

28. The window of claim 25, wherein the quantity, the thicknesses, and materials of the alternating layers of the first and second layered films are configured so that the window has an average percentage transmittance, calculated over the 50 nm wavelength range of interest, of greater than 90% for light incident on the first surface and the second surface at angles of incidence of less than or equal to 15°.

29. The window of claim 25, wherein the quantity, the thicknesses, and materials of the alternating layers of the first and second layered films are configured so that the window has an average reflectance, calculated throughout the visible spectrum, for light normally incident on the first layered film, of less than or equal to 30%.

30. (canceled)

31. (canceled)

32. The window of claim 25, wherein the quantity, the thicknesses, and materials of the alternating layers of the first and second layered films are configured so that the window has an average percentage transmittance, calculated over the 50 nm wavelength range of interest, of greater than 99.5% for light normally incident on the first surface and the second surface.

33. (canceled)

34. The window of claim 25, wherein a hardness, measured at the first layered film and by the Berkovich Indenter Hardness Test, is at least 8 GPa over a depth range of 300 nm to 2000 nm.

35. The window of claim 25 wherein:
one of the alternating layers of the first layered film that is farthest from the substrate forms a terminal surface material of the window, the terminal surface material of the window comprising the lower refractive index material,
the first layered firm comprises a scratch resistant layer formed of one of the one or more higher refractive index materials and having a thickness that is greater than or equal to 1500 nm and less than or equal to 5000 nm,
the scratch resistant layer is separated from the terminal surface by at least 1000 nm, and
a layer of the alternating layers of the second layered film most proximate to the substrate is a layer of the lower refractive index material and comprises a thickness of less than or equal to 50 nm.

36.-54. (canceled)
